(19) United States
(12) Patent Application Publication
(10) Pub. No.: US 2025/0376163 A1
(43) Pub. Date: Dec. 11, 2025

(54) ADAPTIVE CRUISE CONTROL BASED ON REAL-TIME DDS MIDDLEWARE

(71) Applicant: KING FAHD UNIVERSITY OF PETROLEUM AND MINERALS, Dhahran (SA)

(72) Inventors: Basem ALMADANI, Dhahran (SA); Najood ALSHAMMARI, Dhahran (SA); Anas ALROUBAIEY, Dhahran (SA)

(73) Assignee: KING FAHD UNIVERSITY OF PETROLEUM AND MINERALS, Dhahran (SA)

(21) Appl. No.: 18/734,749

(22) Filed: Jun. 5, 2024

(51) Int. Cl. B60W 30/16; B60W 30/09; H04L 65/1059; H04L 67/125

(52) U.S. Cl. CPC B60W 30/162; B60W 30/09; H04L 65/1059; H04L 67/125

(57) ABSTRACT

An automatic cruise control (ACC) system for vehicles and a method for communication therein are provided. The ACC system includes vehicle sensors configured to measure vehicle parameters and generate sensor data; vehicle controllers configured to receive a subset of the sensor data and actuate a vehicle automatic cruise control component; a distributed data services (DDS) bus connected to each of the plurality of vehicle sensors and each vehicle controller; and a publisher/subscriber DDS middleware connected to the DDS bus configured to bi-directionally communicate between each of the plurality of vehicle sensors and each of the plurality of vehicle controllers. The vehicle sensors are configured as a publisher of respective sensor data. The vehicle controllers are configured as a subscriber to a subset of the sensor data and as a publisher of topics generated by the respective vehicle controller. QOS policies govern the behavior of the topics.

### STATEMENT REGARDING PRIOR DISCLOSURE BY THE INVENTORS

Aspects of this technology are described in an article titled “Adaptive Cruise Control Based On Real-Time DDS Middleware” published by IEEE Access, Vol. 11, pp. 75407-75423, on Jul. 17, 2023, which is incorporated herein by reference in its entirety.

### BACKGROUND

### Technical Field

The present disclosure is directed to automotive control systems, more specifically to an advanced Adaptive Cruise Control (ACC) system that leverages Real-Time Publish-Subscribe (RTPS) middleware, particularly Data Distribution Services (DDS), to enhance real-time data exchange, interoperability, and system responsiveness in vehicular environments.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

As traffic on highways has steadily risen, greater congestion has resulted, resulting in vastly increased traffic oscillations, also known as the “stop-and-go” traffic (which refer to the phenomenon that congested traffic tends to oscillate between slow-moving and fast-moving states rather than maintain a steady state) and increased accidents [See: Y. Li, Z. Li, H. Wang, W. Wang, and L. Xing, “Evaluating the safety impact of adaptive cruise control in traffic oscillations on freeways, “Accid,” Accid. Anal. Prev, vol. 104, pp. 137-145, 2017].

Furthermore, according to the National Highway Traffic Safety Administration (NHTSA), an estimated 31,720 individuals have died in motor vehicle traffic accidents between January and September 2021. The statistics represent the greatest number of fatalities in the first nine months of any year since 2006 and the largest percentage rise in the Fatality Analysis Reporting System's history [See: “Home,” NHTSA. (Online). Available: https://www.nhtsa.gov. (Accessed: 24 Jun. 2022), and “Early Estimate of Motor Vehicle Traffic Fatalities for the First 9 Months (January-September) of 2021,” Dot.gov, February-2022]. Adaptive Cruise Control (ACC) systems have emerged as a critical technology in addressing these challenges. ACC not only fulfills safety requirements, it also provides comfort for the driver and the passengers even in perilous traffic maneuvers, as it may alleviate driver stress by automatically adjusting the speed of the vehicle and maintaining a predetermined minimum distance from the preceding vehicle [See: N. A. Stanton and M. S. Young, “Driver behaviour with adaptive cruise control,” Ergonomics, vol. 48, no. 10, pp. 1294-1313, 2005]. As a result, the driver is more comfortable and can focus better on the traffic.

ACC is an extension of the conventional cruise control system that is widely used in many commercial vehicles. The objective an ACC system is to replace the driver in terms of operating the throttle pedal and the brake pedal in order to control the speed of the vehicle, acceleration, deceleration and braking, in many different situations, whether it is in traffic jams, in a cut-in situation, cut-out situation or in a situation where a vehicle ahead brakes to avoid an accident ahead. The ACC system controls the vehicle to maintain a safe desired distance in relation to a leading vehicle. ACC systems have become an integral part of modern vehicular safety and comfort, aiming to alleviate driver workload, especially in dense traffic conditions or long drives. By automatically regulating speed and distance from the vehicle ahead, ACC systems play a role in maintaining traffic safety and flow.

The ACC system can be based on either an end-to-end controller or a hierarchical controller. The end-to-end controller is a main controller where the input is taken from sensors and processed by the controller producing the desired torque. On the other hand, the hierarchical structure is built on an upper controller and a lower controller. Each controller plays a significant role in the control structure of ACC. The lower controller is a control layer while the upper controller works as a decision layer. When the road is clear and there are not any leading vehicles ahead of the vehicle with ACC, the vehicle maintains a speed that was initially pre-set by the driver and that is called a speed control mode. On the other hand, if there is a leading vehicle ahead of the vehicle with ACC, the vehicle with ACC is in a distance control mode. In the case of the distance control mode, the upper controller executes a longitudinal car-following model along with an optimization algorithm.

To control the acceleration, an optimal control instruction and command is calculated by the upper controller, depending on the motion state of both vehicles, the leading vehicle and the vehicle with ACC. On the other hand, the switching logic and the braking force are contained within the lower controller. The switching logic usually contains the vehicle's drive control strategy for the motor in addition to a brake control strategy. The braking force is a distribution strategy that includes the distribution strategy of braking force for the vehicle's axles (front and rear). In other words, whenever the driver activates the ACC, the upper controller starts taking information from the equipped sensors and calculates the optimal trajectory, acceleration, and speed. After that, the lower controller takes action and begins to execute the trajectory calculated by the upper controller and send low-level instructions to the vehicle control interface.

As mentioned, the controllers hold major significance in ACC. This has drawn researchers' attention to design of the controllers. There are many different algorithms that have been proposed and employed in design of the controller. These algorithms include fuzzy control, Model Predictive Control (MPC), deep reinforcement learning, Robot Operating System 2 (ROS2), Action Dependent Heuristic Dynamic Programming (ADHDP), among others. However, these conventional control strategies are often constrained by the inherent limitations of hierarchical structures, affecting system responsiveness and adaptability.

Further, there are multiple adaptive cruise control and middleware based studies in the art. De Yang et al. [See: Z. Yang, Z. Wang, and M. Yan, “An optimization design of adaptive cruise control system based on MPC and ADRC,” Actuators, vol. 10, no. 6, p. 110, 2021] proposed an optimal design for an ACC system based on MPC and Active disturbance rejection control (ADRC) compensatory control. The MPC approach was implemented as the top controller of the hierarchical design in order to improve safety, tracking capabilities, fuel economy, and ride enjoyment. The MPC may provide a suitable command to the lower controller during each sample time period based on all available information. However, if the prediction model is inaccurate, it is hard to obtain a suitable response; as a result, a predictive acceleration estimator based on the least square approach was developed. Utilizing this acceleration predictive estimation (APE) approach in the MPC framework when the front target vehicle accelerates or decelerates can increase control accuracy. Once the desired acceleration has been attained, the throttle or brake actuator is modulated to monitor the planned acceleration. As a result, the lower-level controller of the reference made use of acceleration feedback and compensatory control techniques such as ADRC and vehicle dynamic model (VDM). When the host vehicle is subjected to internal or external disturbances, this facilitates the host vehicle to follow the front target vehicle.

Zhang and Zhuan [See: S. Zhang and X. Zhuan, “Study on adaptive cruise control strategy for battery electric vehicle,” Math. Probl. Eng., vol. 2019, pp. 1-14, 2019] examined the control strategy for an ACC system on a Battery Electric Vehicle (BEV) during the car-following method, with the primary focus being on the incorporation of regenerative braking in a BEV during the car-following operation. The ACC system was structured in a hierarchical manner. Additionally, the structure was controlled by an upper and lower controller. The higher controller improved various objectives, including safety, monitoring, comfort, and energy consumption, by utilizing the MPC approach. Energy was recovered in the lower controller during braking. The ACC technique was evaluated using simulation, and demonstrated safe tracking for the leading car.

Wei et al. [See: Z. Wei et al., “End-to-end vision-based adaptive cruise control (ACC) using deep reinforcement learning,” in The Transportation Research Board (TRB) 99st Annual Meeting, Washington D.C., Jan. 12-16, 2020, 2020 presented double deep Q-networks as a deep reinforcement learning technique for building an end-to-end vision-based ACC system. To create a simulation environment resembling a highway situation, a gaming engine was used that included both real-world automotive models and feature data for learning and testing. A reward mechanism was integrated into the reinforcement learning model for both Internal Combustion Engine (ICE) vehicles and EV to conduct ACC. Additionally, the gap statistics and total energy consumption for a variety of vehicle types were analysed in order to determine the link between incentive systems and engine parameters. Compared to existing radar-based ACC systems or human-in-the-loop simulations, the vision-based ACC system may give a more gap-controlled or shorter velocity route, depending on the optimization strategy used. The suggested technology operates in real time and is capable of adapting to the changing speed trajectories of the vehicle ahead.

Chen et al. [See: Y. Chen, G. Feng, S. Wu, and X. Tan, “A new hybrid model predictive controller design for adaptive cruise of autonomous electric vehicles,” J. Adv. Transp., vol. 2021, pp. 1-25, 2021] proposed a hybrid MPC controller based on a simplified dual neural network (SDNN) and a proportional integral derivative (PID) focusing on a single neuron (SN) for ACC control of autonomous electric vehicles, with the objective of balancing comfort, tracking, safety, and energy economy while taking spatiotemporal constraints between the leading and following vehicles into account. Following and cruising modes were specified and implemented using the MPC algorithm based on SDNN and the PID controller based on SN, respectively. Typically, conventional ACC systems neglect lateral dynamics control; but, in this case, it was considered, resulting in the ACC system being able to work on the curved road. The braking approach was also demonstrated to be successful in simulations.

Reke et al. [See: M. Reke et al., “A Self-Driving Car Architecture in ROS2,” in 2020 International SAUPEC/RobMech/PRASA Conference, 2020] presented a ROS2-based architecture for a self-driving vehicle in this study. Self-driving cars must make real-time judgements based on sensory information, necessitating both high reliability and a high level of functional safety. Additionally, this article explained how ROS, in particular, may not always meet these standards. On the other hand, the successor ROS2 been offered as a solution for autonomous driving. Additionally, the current existing ROS-based robotic software has been shown to be insufficient for safety-critical applications such as self-driving cars. This paper presented an architecture for a self-driving vehicle based on ROS2 that facilitates safe and predictable real-time behavior while keeping ROS's distributed design and standardized message formats. Their initial testing using an automated real-world passenger vehicle at both high and low speeds suggest that their method is viable for autonomous driving under the requisite real-time conditions.

Adiththan and Ravindran [See: A. Adiththan and K. Ravindran, “QoS-oriented management of multi-vehicle coordinated cruise control in uncertain environments,” in Proceedings of the 6th ACM Symposium on Development and Analysis of Intelligent VehicularNetworks and Applications—DIVANet '17, 2017y] discussed methods for evaluating the QoS capabilities of networked embedded software systems. Given a target system S, its internal algorithmic processes and component subsystems can be adjusted to facilitate it to cope efficiently with hostile environment conditions that may emerge. The research gave a case study of cruise control systems in automobiles to evaluate their assessment and reconfiguration methodologies. They demonstrated the problems inherent in properly coordinating a large number of vehicles in the face of adverse environmental conditions (such as slipperiness, altitude, signalling message loss, and so on), while striving to meet per-vehicle QoS standards. Their model-based engineering methodologies assess several networked embedded systems with identical functional objectives against certain non-functional attributes and facilitate the planning of bigger network installations with predictable behaviour using a system-of-systems composition.

Reschka et al. [See: A. Reschka, M. Nolte, T. Stolte, J. Schlatow, R. Ernst, and M. Maurer, “Specifying a middleware for distributed embedded vehicle control systems,” in 2014 IEEE International Conference on Vehicular Electronics and Safety, 2014] suggested that the critical factors to consider are the work required to test a software update and the vast diversity of possible settings accessible in distinct automotive models. The need for software that facilitates such updates, monitors for new software versions, and offers reconfiguration procedures for individual control units and dispersed groups of control units were analyzed. The total vehicular environment, including space, electric power, processing power, and cost limits, as well as four example road car automation systems and a complete x-by-wire target vehicle for performing these applications was studied, in order to identify the requirements. The examination of these three distinct demand sources elucidates important middleware features and needs, particularly in terms of runtime and update lengths. The criteria include capability for updating with built-in authentication, application exchange on single control units, and capability loss and take-to-control unit relocation.

Bai et al. [See: Y. Bai, Z. Wang, X. Wang, and J. Wang, “AutoE2E: End-to-end real-time middleware for autonomous driving control,” in 2020 IEEE 40th International Conference on Distributed Computing Systems (ICDCS), 2020] argued that the rapid use of self-driving autos spawned a new study area in vehicle management system real-time scheduling. After examining classic open-loop scheduling techniques used in autos and reactive real-time scheduling strategies advocated for general distributed real-time embedded (DRE) technologies, the authors decided that a novel real-time scheduling solution should be developed based on a unique characteristic of driving management. AutoE2E, a two-tier software system was proposed for automobile operating systems, which managed to overcome the shortcomings of existing solutions by leveraging a second-tier controller to dynamically reduce runtime within reasonable parameters in order to reclaim efficient CPU usage control for End-to-End (E2E) real-time promises. AutoE2E has been assessed on a physical test platform using miniature automobiles as well as in a larger-scale simulation. The results revealed that AutoE2E beat a cutting-edge system solely based on rate adaptation by 35.4 percent in terms of target miss ratio over the same time period, while also minimizing route tracking error.

Chen et al. [See: X. Chen, J. Yang, C. Zhai, J. Lou, and C. Yan, “Economic adaptive cruise control for electric vehicles based on ADHDP in a car-following scenario,” IEEE Access, vol. 9, pp. 74949-74958, 2021] proposed a model-free ADHDP-based Eco-ACC approach for EVs operating in a car-following scenario in order to improve vehicle safety, battery life, ride comfort, and energy efficiency. The simulated results indicate that the Eco-ACC technique may help keep the EV on track with the automobile ahead of it and greatly minimize battery capacity loss and cut energy consumption. Additionally, the proposed Eco-ACC is model-independent, real-time, and robust to a variety of car-following scenarios.

Zhao et al. [See: R. C. Zhao, P. K. Wong, Z. C. Xie, and J. Zhao, “Real-time weighted multi-objective model predictive controller for adaptive cruise control systems,” Int. J. Automot. Technol., vol. 18, no. 2, pp. 279-292, 2017] developed a novel spacing control law that improves fuel efficiency and ride comfort, resulting in increased driving safety. This control rule is intended to be used as the upper-level controller in an ACC system based on model predictive control and a real-time weight tuning technique for calculating the optimal desired acceleration. During the transitional maneuvers (TMs), the proposed spacing control law might simultaneously achieve control objectives such as high fuel efficiency and riding comfort. To improve fuel efficiency across TMs, the proposed spacing control regulation based on MPC employs a new compromise control strategy that takes into account creating a safe inter-vehicle gap with zero relative velocity behind a vehicle ahead. Due to the complexity of the inter-vehicle statements used in TMs, a real-time weight tuning approach was also developed and applied to the spacing control rule, resulting in an optimal control command. The host vehicle may smoothly generate a safe inter-vehicle distance while boosting ride happiness and fuel economy, but does not account for vehicle safety, energy consumption, passenger comfort, and time-varying problems.

Luu et al. [See: D. L. Luu, C. Lupu, and T. Van Nguyen, “Design and simulation implementation for adaptive cruise control systems of vehicles,” in 2019 22nd International Conference on Control Systems and Computer Science (CSCS), 2019] used Matlab/Simulink to construct a simulation engine for platoons of ACC autos. Because the driver in a platoon establishes the velocity reference, it was governed using the usual CC method. A control legislation for ACC vehicles has been created in accordance with the constant time gap (CTG) spacing strategy. To pursue the leader vehicle at a preferred range that is dependent on the vehicle, the exact distance being determined using a sensor such as radar range and range rate sensors, in order to accomplish the mission of maintaining the desired spacing and relative velocity of the vehicle ahead that does not require the use of current traffic infrastructure.

Chen et al. [See: X.-W. Chen, J.-G. Zhang, and Y.-J. Liu, “Research on the intelligent control and simulation of automobile cruise system based on fuzzy system,” Math. Probl. Eng., vol. 2016, pp. 1-12, 2016,] provided an intelligent fuzzy control system for combining throttle and brake control in order to perform ACC and Stop & Go operations inside a single control framework. A simulation module for automobile intelligent cruise control is developed using MATLAB/Simulink and is based on vehicle dynamics modeling, with test data from a 1.6 L car equipped with four-speed automatic gearboxes serving as an example. The results of the testing cases demonstrate that the proposed fuzzy control approach is effective and feasible, capable of performing not only high-velocity ACC and low-velocity Stop & Go control duties, but also normal cruise control functions.

Patel et al. [See: A. R. Patel, N. B. Haupt, and P. Liggesmeyer, Evaluating adaptation behavior of adaptive cruise control (ACC) in autonomous vehicles] discussed a philosophical and model-based technique for changing the behavior of the ACC system in autonomous automobiles. The main notion is to employ adaptive systems inside safety monitoring in the event of a system fault and to automatically trigger a new safe reconfiguration to counteract the dangerous configuration. Numerous situations and environmental conditions were used to perform a complete case study of the ACC system's adaptive activity during runtime. Matlab/Simulink was used to develop the modeling environment and to determine the feasibility of the ACC system requirements and a related system component.

Furthermore, there are numerous data distributed services middleware based studies. Al-Madani and Ali [See: B. Al-Madani and H. Ali, “Data Distribution Service (DDS) based implementation of Smart grid devices using ANSI C12. 19 standard,” Procedia Comput. Sci, vol. 110, pp. 394-401, 2017] suggested that as a result of inefficient peak-load management, concentrated power generation, restricted information flow, and inadequate distribution assistance, today's electric grid faces several difficulties. Several groups are working on Smart grid as a result of these restrictions. The proliferation of heterogeneous devices in a smart grid only serves to exacerbate the problem of increased complexity and inefficiency. Middleware is regarded the best solution for dealing with the heterogeneity of various devices and ensuring interoperability. Data Distribution Service (DDS) middleware delivers high levels of dependability and efficiency by addressing additional performance indicators and numerous QoS criteria, particularly in real-time and mission-critical operations, despite the fact that many middlewares have been presented. An ANSI C12.19-based DDS implementation has been studied for transmission and consumption. To facilitate connection and carry out experimental investigation for the assessment of interoperability and other performance metrics, data structures are obtained for topics formation over RTI Connext in order to demonstrate that DDS is an ideal option for Smart grid data interoperability and high reliability.

Llorens-Carrodeguas et al. [See: A. Llorens-Carrodeguas, C. Cervello-Pastor, and I. Leyva-Pupo, “A data distribution service in a hierarchical SDN architecture: Implementation and evaluation,” in 2019 28th International Conference on Computer Communication and Networks (ICCCN), 2019,], proposed a novel technique to distributing software-defined network (SDN) domains using DDS. This study argues that paradigm change in communication networks has occurred because of software-defined network (SDN) technology, which provides networks to be programmed by using centralized or decentralized controllers. New verticals, such as Industry 4.0, cooperative sensing, and virtual reality, have evolved as a result of the evolution of the industry. The usage of scattered domains is required to increase network scalability and durability in these sectors. DDS was used to distribute SDN subdomains in this article. The DDS facilitates network information interchange, controller synchronization, and self-discovery. Furthermore, it enhances the control plane's resilience, which is critical for 5G networks. Using SDN controllers, a testbed was built to evaluate the DDS's efficacy, and then deployed to test the latency and overhead of controller-to-controller communication.

Madden and Ghalaab [See: M. M. Madden and P. C. Glaab, “Distributed simulation using DDS and cloud computing,” in Proceedings of the 50th Annual Simulation Symposium, 2017, pp. 1-12] determined that a distributed simulation architecture was required by NASA Langley Research Center in order to facilitate collaboration across real, virtual, and constructive nodes from across LAN, as well as extensibility to other NASA Facilities and external parties. In one configuration, the GovCloud cloud computing service was combined with the DDS middleware. Data was sent between the nodes through DDS. There is a potential approach to facilitate other units and partners to access the distributed simulation over an established secure network, avoiding the requirement to negotiate individual interconnection security agreements. Piloted and unpiloted aircraft exchanged Auto-Dependent Surveillance Broadcast (ADS-B) signals using the prototype design. In order to evaluate the development in terms of upfront investment to enhance a node's design, connectivity and interoperability of nodes, performance, integration and security, various node configurations were run and reviewed.

El-Ferik et al. [See: S. El-Ferik, B. Almadani, and S. M. Elkhider, “Formation control of multi unmanned aerial vehicle systems based on DDS middleware,” IEEE Access, vol. 8, pp. 44211-44218, 2020], discussed unmanned aerial vehicle system (UAV) formation control. DDS middleware is used to guide the multi-UAV agents through the L1 controller. The L1 adaptive controller is utilized to stabilize the general motion equations of each UAV, while the potential field approach is employed to formalize the following UAVs around the leader. DDS publisher/subscriber middleware is used to exchange data between both the leader and the followers. An adaption of the L1 controller resulted in a high level of performance. The L1 controller's robustness was tested using Matlab Simulation. The analysis and stability of the framework of UAVs were supplied by the Lyapunov approach.

Almadani et al. [See: B. Almadani, S. Khan, M. N. Bajwa, T. R. Sheltami, and E. Shakshuki, “AVL and monitoring for massive traffic control system over DDS, “Mob,” Mob. Inf. Syst, vol. 2015, pp. 1-9, 2015] proposed a real-time Automatic Vehicle Location (AVL) and monitoring system for traffic control of pilgrims traveling towards the Saudi Arabian city of Makkah in this study. The system is built on the DDS. Many-to-many communication paradigm ideal for use in enormous traffic control applications is implemented using Real-Time Publish/Subscribe (RTPS) protocol, which is implemented by DDS-based middleware. This middleware technique facilitates to find and monitor a large number of mobile cars while also identifying all passengers in real-time who are traveling to Mecca to complete the annual Hajj ritual. Various performance metrics are investigated via WLAN utilizing DDS in order to verify the validity of the proposed framework. The results demonstrate that DDS-based middleware is capable of meeting real-time requirements in a large-scale AVL setting.

Cantelli-Forti et al. [See: A. Cantelli-Forti, A. Capria, A. L. Saverino, F. Berizzi, D. Adami, and C. Callegari, “Critical infrastructure protection system design based on SCOUT multitech seCurity system for interconnected space control ground stations,” Int. J. Crit. Infrastruct. Prot., vol. 32, no. 100407, p. 100407, 2021] suggest that increasing efforts are needed to ensure the safety of essential infrastructure, considering both cyber and physical attack vectors when protecting against inexpensive unmanned vehicles, especially for Internet of Things (IoT) or hardware threats. The reference suggests that more robust and precise technologies is needed in these situations and discusses requirement analysis and demonstration system performance, anti-cyber-attack technologies and methods for detecting foreign physical items. Examples and trials of the SCOUT Multitech Security system for interconnected space control ground stations were made. The DDS ensured interoperability of the SCOUT systems. The DDS standard was implemented in Vortex OpenSplice. All actors in the SCOUT system subscribed to the DDS subject in order to publish their data. Each subsystem had an agent installed that was able to recognize new data and respond appropriately. The data was analyzed, transferred to the central DDS system, and sent to the receiving system via server message block protocol (SMB). DDS subscribers may see the new instance and pick up a newly transmitted file from their system.

Ibarra-Junquera et al. [See: V. Ibarra-Junquera, A. Gonzalez-Potes, C. M. Paredes, D. Martinez-Castro, and R. A. Nunez-Vizcaino, “Component-based microservices for flexible and scalable automation of industrial bioprocesses,” IEEE Access, vol. 9, pp. 58192-58207, 2021] proposed a holistic framework for the purpose of bridging the gap between generic designs and physical implementations of industrial bioprocesses by using their framework for flexible and scalable automation. In the holistic approach, a system and its attributes are studied comprehensively, as a whole, rather than as the sum of its components. To facilitate rapid design and implementation in the bioprocess industry, a software design pattern based on components, container technology, microservices concepts, and the publish/subscribe paradigm was defined. This pattern defined a set of components with offer and request services that can be easily connected via the plug-and-play technique and interconnected with a middleware based on the publish/subscribe pattern such as DDS. To show the suggested framework's applicability, two processes in the fruit juice drinks business were devised and executed at the Punta Delicia S. A. de C. V. juice manufacturing facility in Colima, Mexico. A method for manufacturing soursop soda was presented, with a fuzzy controller used to maintain a constant pasteurizer output flow (UHT) and an automated storage tank selection and filling procedure using actuated valves to route the fluid to the appropriate tank when the process is started. The results indicated that the platform provided a high-fidelity environment for designing, analyzing, and testing the flow of cyber information and its effect on physical operation in a beverage processing plant with a high demand for adaptability, flexibility, and efficiency of its processes, as demonstrated experimentally in a real production process for the production of 860 L of soursop. Each development was addressed individually until the procedures were optimized, resulting in cost savings associated with development and final application. Finally, in each of the case studies provided, both general and specific needs were addressed, demonstrating the framework's adaptability, scalability, and resilience.

Other proposals have been made in the art to address the above stated challenges. For instance, US Patent Publication No. 20180237040A1 describes a powered system, which can be an automobile, which has a control system. Communication among devices is by a data distribution service. The data distribution service represents an object management group (OMG) device-to-device middleware communication standard between the devices and the network. The data distribution service facilitates communication between publishers and subscribers. The term publisher refers to devices that send data to other devices and the term subscriber refers to devices that receive data from other devices. The communication system may use the network to communicate data between or among the devices using the data distribution service to maintain QoS parameters of certain devices. A QoS parameter can dictate a lower limit or minimum on data throughput in communication between or among two or more devices. The QoS parameter can be used to ensure that data communicated with one or more devices to one or more devices and/or between two or more devices is received in a timely manner. However, this reference does not mention that publishers can have multiple data writers, and subscribers can also have multiple data readers.

CN Patent Reference No. 113734166A, incorporated herein by reference in its entirety, describes an ACC controller in an automobile, in which devices in the automobile communicate by perception fusion through a middleware run-time environment (RTE). This system includes a forward-looking camera data transceiver module, a front millimeter-wave radar data transceiver module, a signal middleware interface RTE module, a perception fusion SWC module, an automatic emergency braking AEB function perception fusion SWC, and an adaptive cruise ACC function perception fusion SWC. However, this reference does not mention that publishers can have multiple data writers and subscribers can also have multiple data readers, nor appear to mention QOS parameters.

Safety mechanisms using the DDS middleware in software-defined cars are discussed in Seemann, J. “Safety mechanisms using the DDS middleware in software-defined cars,” NXP Semiconductors, Netherlands. The middleware is a software library that facilitates distributed system components to communicate with each other. The safety of software-defined cars highly depends on the middleware and the underlying network processors for reliable real-time data communication among distributed processes; “the data distribution service (DDS) middleware software running across the Cortex-A53 and Cortex-M7 cores in the S32G manages the data and communication of the distributed system. The DDS middleware protocol is based on the publish-subscribe pattern that is standardized by the object management Group® (OMG).”; “DDS comes with a rich set of built-in quality of service (QOS) policies that control the DDS behavior”. However, this reference does not provide any details about the real-time publish-subscribe model for the ACC system, nor mention that publishers can have multiple data writers and subscribers can also have multiple data readers.

Each of the aforementioned references suffers from one or more drawbacks hindering their adoption. The primary challenge is that the conventional ACC systems have a hierarchical structure. None of the references proposes a messaging oriented real-time middleware for adaptive cruise control to integrate the subsystems and the different controllers of the ACC system, specifically which clearly distinguish between publishers and subscribers. Accordingly, it is one object of the present disclosure to provide systems and methods for an ACC system design that overcomes the constraints of conventional hierarchical controllers and provides an integrated, responsive, and adaptable framework,

### SUMMARY

In an embodiment, an automatic cruise control (ACC) system for vehicles is described. The ACC system comprises a distributed data services (DDS) databus. The ACC system further comprises a plurality of vehicle sensors connected to the DDS databus. Herein, each vehicle sensor is configured to measure a vehicle parameter and publish a sensor data topic including the measurement of the vehicle parameter. The ACC system further comprises a plurality of vehicle controllers connected to the DDS databus. Herein, each vehicle controller is configured to subscribe to a subset of the sensor data topic and publish a vehicle control topic based on the subset of the sensor data topic. The ACC system further comprises a plurality of vehicle actuators connected to the DDS databus. Herein, each vehicle actuator is configured to subscribe to the vehicle control topic and actuate an ACC component based on the vehicle control topic. The ACC system further comprises a publish/subscribe DDS middleware connected to the DDS databus. Herein, the publish/subscribe DDS middleware is configured to facilitate near-field communication between each of the plurality of vehicle sensors, the plurality of vehicle controllers and the plurality of vehicle actuators.

In another embodiment, a method for communication in an automatic cruise control (ACC) system for vehicles is described. The method comprises obtaining a distributed data services (DDS) databus. The method further comprises connecting a plurality of vehicle sensors to the DDS databus. Herein, each vehicle sensor is configured to measure a vehicle parameter. The method further comprises configuring each vehicle sensor as a publisher of a sensor data topic including the measurement of the respective vehicle parameter. The method further comprises connecting a plurality of vehicle controllers to the DDS databus. The method further comprises configuring each vehicle controller as a subscriber to a subset of the sensor data topic and as a publisher of a vehicle control topic based on the subset of the sensor data topic. The method further comprises connecting a plurality of vehicle actuators to the DDS databus. The method further comprises configuring each vehicle actuator as a subscriber to the vehicle control topic which actuates an ACC component based on the vehicle control topic. The method further comprises connecting a publish/subscribe DDS middleware to the DDS databus. The method further comprises configuring the publish/subscribe DDS middleware to facilitate near-field communication between each of the plurality of vehicle sensors, the plurality of vehicle controllers and the plurality of vehicle actuators.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of an automatic cruise control (ACC) system connected to a DDS databus, according to certain embodiments.

FIG. 2 is an exemplary illustration of dynamic interaction between components of the ACC system, according to certain embodiments.

FIG. 3 is a schematic diagram depicting a publish/subscribe relationship framework between cruise control switches and an instrument cluster of the ACC system, according to certain embodiments.

FIG. 4 is a schematic diagram of a braking system for the ACC system, according to certain embodiments.

FIG. 5 is a schematic diagram of a brake control system for the ACC system, according to certain embodiments.

FIG. 6 is a schematic diagram of an ACC controller system for the ACC system, according to certain embodiments.

FIG. 7 is a schematic diagram of a RADAR system for the ACC system, according to certain embodiments.

FIG. 8 is a schematic diagram of a relationship framework between the instrument cluster and an ACC controller for the ACC system, according to certain embodiments.

FIG. 9 is a schematic diagram of a speed sensors system for the ACC system, according to certain embodiments.

FIG. 10 is an exemplary flowchart of a method for communication in the ACC system, according to certain embodiments.

FIG. 11 is an exemplary graphical depiction of an end-to-end delay of ACC messages for different numbers of nodes in the ACC system, according to certain embodiments.

FIG. 12 is an exemplary graphical depiction of packet delivery ratio for the ACC system, according to certain embodiments.

FIG. 13 is an exemplary graphical depiction of memory requirement for the ACC system, according to certain embodiments.

FIG. 14 is an illustration of a non-limiting example of details of computing hardware used in the computing system, according to certain embodiments.

FIG. 15 is an exemplary schematic diagram of a data processing system used within the computing system, according to certain embodiments.

FIG. 16 is an exemplary schematic diagram of a processor used with the computing system, according to certain embodiments.

FIG. 17 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to an automatic cruise control (ACC) system for vehicles and a method for communication in the ACC system. The ACC system is a solution that facilitates drivers to minimize the amount of time they spend driving. The ACC system essentially supports four different driving modes on the road and regulates the acceleration and deceleration of the vehicle in order to maintain a fixed speed or avoid a collision with another vehicle. Whenever there is an unanticipated delay in responses of real-time adaptive cruise control components, it may result in the loss of human lives. Due to the crucial nature of the timing aspect in such applications, the time delay should be kept to a minimum by using a very tight window timeframe. Real-Time Publish-Subscribe (RTPS) middleware has emerged as one of the most efficient and practical options for real solutions to the difficulties listed above.

The present disclosure proposes a near real-time system for integrating the various components of adaptive cruise control. These components include the following: the information cluster, the radar, brake switches, cruise control switches, the ACC controller, the engine/throttle controller, a brake controller, brake actuators, speed sensors, and back brake lights. Specifically, the present disclosure provides a messaging oriented real-time middleware for adaptive cruise control to integrate the subsystems and the different controllers of the ACC system. Moreover, the conventional ACC systems usually follow a hierarchical structure where there is an upper controller and a lower controller. The present disclosure proposes an approach that eliminates the hierarchical structure of information flow. The exchange of data is through a real-time publisher/subscriber Data Distribution Service (DDS) middleware. The design of the publish/subscribe model has been explained in the proceeding paragraphs of the present disclosure along with the proper Quality of Service (QOS) policies to govern the behavior of the model.

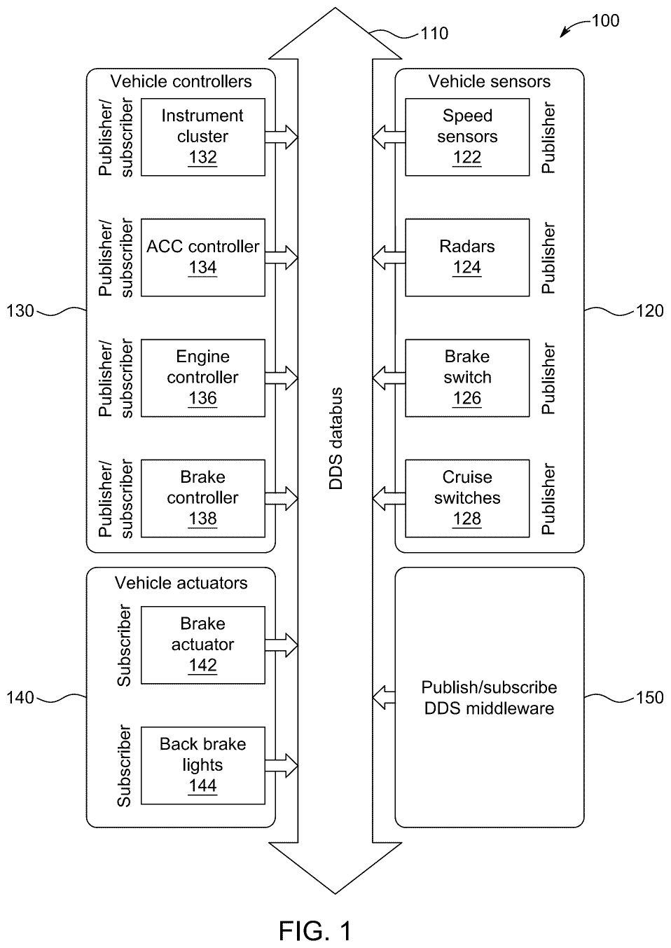

Referring to FIG. 1, illustrated is a schematic diagram of an automatic cruise control (ACC) system (as represented by reference numeral 100) for vehicles. Particularly, in the illustration of FIG. 1, data exchange between different components of the ACC system 100 is depicted. The ACC system 100 demands a high-speed information flow and exchange as it is considered mission critical for the vehicles, and any latency in an information arrival can lead to a deadly accident. The ACC system 100 is a sophisticated network of real-time communication and control, designed to navigate the complexities of vehicular operation in a variety of driving conditions. The architecture of the ACC system 100 is designed to handle the continuous stream of data required for maintaining vehicle performance, safety, and compliance with traffic regulations. The ACC system 100, by automating speed control and distance management from other vehicles, alleviates workload of the driver, particularly over long distances or in congested traffic scenarios. This automation is achieved through a complex interplay of sensors and controllers that continuously collect and analyze data to make real-time decisions. The ACC system 100 is an integration of multiple components working in unison to ensure the optimal functioning of the vehicle. This integration provides harmonized operation that can adaptively adjust to the dynamic nature of driving environments.

As illustrated in FIG. 1, the ACC system 100 includes a distributed data services (DDS) databus 110. The DDS databus 110 serves as the communication backbone of the ACC system 100, interconnecting all system components to facilitate efficient and reliable data exchange. The DDS databus 110 is configured to handle the high-bandwidth requirements of modern vehicular systems and is particularly adapted to manage the real-time operational demands of the ACC system 100. In an aspect of the present disclosure, the DDS databus 110 is designed to support a distributed network of vehicle components, providing a scalable system that can accommodate additional sensors and controllers as needed. This design choice provides individual components to be modified or replaced without the need for extensive system-wide reconfigurations. It may be appreciated that the DDS databus 110 is not a physical bus but a software layer or system, and components of the ACC system 100 are first registered with the DDS software system, which configures it according to its policies. By leveraging the capabilities of the DDS databus 110, the ACC system 100 ensures that data transmission between sensors, controllers, and actuators occurs with minimal latency, facilitating prompt response to dynamic driving conditions.

The ACC system 100 also includes a plurality of vehicle sensors 120 connected to the DDS databus 110. Each vehicle sensor 120 is configured to measure a vehicle parameter and publish a sensor data topic including the measurement of the vehicle parameter. The vehicle sensor 120 are connected to the DDS databus 110 transmitting data between components with speed and reliability, as required for automotive applications. Each vehicle sensor 120 may be configured to measure a specific vehicle parameter, such as speed, distance, or acceleration. Upon acquiring this data, the vehicle sensor 120 is configured to publish the sensor data topic to the DDS databus 110. The vehicle sensors 120 operate as publishers, broadcasting sensor data topics to the DDS databus 110. The use of a publisher model ensures that data from the vehicle sensors 120 is made available to all relevant system components in real time, for the functioning of the ACC system 100. Herein, the sensor data topic includes the precise measurement of the vehicle parameter it is assigned to monitor. The sensor data topics, published by the vehicle sensors 120, are structured and encoded in a manner that provides for immediate identification and utilization by other components within the ACC system 100. The publication of the sensor data topics is a continuous process, with each vehicle sensor 120 autonomously sending updates to ensure up-to-date information about state of the vehicle. This design ensures that the information provided by the vehicle sensors 120 is presented timely and in a format ready for the rapid decision-making processes of the ACC system 100.

The ACC system 100 further includes a plurality of vehicle controllers 130 connected to the DDS databus 110. Each vehicle controller 130 is configured to subscribe to a subset of the sensor data topic and publish a vehicle control topic based on the subset of the sensor data topic. The vehicle controllers 130 are components that act as decision-making component in the operation of the ACC system 100. Each vehicle controller 130 is configured to subscribe to the subset of the sensor data topics that are published on the DDS databus 110, selecting the exact information necessary for its specialized function within the ACC system 100. Upon subscription, the vehicle controllers 130 are responsible for processing the received data, applying advanced algorithms, and issuing the vehicle control topics. The vehicle control topics are then published back onto the DDS databus 110 and include instructions for various other control elements within the ACC system 100. The instructions encoded within the vehicle control topics may range from speed adjustments to braking commands, based on the analysis of the data received from the vehicle sensors 120. The ability of the vehicle controllers 130 to publish the vehicle control topics ensures that all system components are consistently synchronized with the latest control strategies, ensuring that behavior of the vehicle is continuously optimized for safety. By subscribing to the relevant sensor data topics, processing the information, and publishing the vehicle control topics, the vehicle controllers 130 provide a distributed yet coordinated control environment for the ACC system 100.

The ACC system 100 further includes a plurality of vehicle actuators 140 connected to the DDS databus 110. Each vehicle actuator 140 is configured to subscribe to the vehicle control topic and actuate an ACC component based on the vehicle control topic. The vehicle actuators 140 are the physical executors within the ACC system 100, translating digital commands into physical actions to adjust operational state of the vehicle. Each vehicle actuator 140 is configured to subscribe to specific vehicle control topics that are published on the DDS databus 110. The vehicle control topics, generated by the vehicle controllers 130, define the required adjustments to be made by the vehicle actuators 140 to control mechanics of the vehicle, such as acceleration, braking, and steering. Upon receipt of the vehicle control topic, the vehicle actuator 140 interprets the command and initiates the appropriate response in its respective ACC component. This ability of the vehicle actuators 140 to actuate components based on the vehicle control topics ensures that the operation of the vehicle is synchronized with the sensed conditions of the driving environment and the intentions of the driver. Moreover, such configuration of the vehicle actuators 140 provides for a near real-time, dynamic response to the continuously evolving driving scenarios. By subscribing to the vehicle control topics, the vehicle actuators 140 ensure that movement of the vehicle is constantly regulated, facilitating the ACC system 100 to provide a safe driving experience.

The ACC system 100 further includes a publish/subscribe DDS middleware 150 connected to the DDS databus 110. The publish/subscribe DDS middleware 150 is configured to facilitate near-field communication between each of the plurality of vehicle sensors 120, the plurality of vehicle controllers 130 and the plurality of vehicle actuators 140. As used herein, the term “near-field communication” refers to the exchange of data over short distances between the various components of the ACC system 100, such as the vehicle sensors 120, the vehicle controllers 130, and the vehicle actuators 140, by employing communication technologies such as Wi-Fi or Bluetooth. This communication is facilitated by the publish/subscribe DDS middleware 150, which is connected to the DDS databus 110. Herein, the publish/subscribe DDS middleware 150 employs a data-centric publish-subscribe model that provides decoupled interactions among system components, meaning that publishers and subscribers can operate independently without direct knowledge of each other. By managing subscriptions and publications of data topics, the publish/subscribe DDS middleware 150 ensures that the data generated by the vehicle sensors 120 is delivered to the appropriate vehicle controllers 130, and that the commands issued by the vehicle controllers 130 are distributed in real-time to the vehicle actuators 140 for immediate action.

As used herein, the DDS is an application programming interface standard that is used to link data centrically. Moreover, the DDS is a middleware platform that is considered a specific type of real-time publish/subscribe platform that utilizes a message passing middleware. A middleware is an interoperability software that acts as a bridge connecting an application program and a network, concealing variations or incompatibilities in network transport protocols, physical infrastructure, system software, distributed databases, and connectionless calls. Further, in heterogeneous computing, middleware can be seen as a way to mask any complexity of the underlying heterogenous environment. Furthermore, DDS consists of API, protocol and presentation. As and when information is being exchanged between different applications, the middleware ensures that information is in a context that can be understood by the receiving end regardless of the operating system that is being used in each application. Herein, the presentation aspect of the middleware includes topics, types, filtering entities. Further, the protocol includes the reliability, discovery and QoS policies (as discussed later in detail). A message-oriented middleware communicates in a ‘single shot’ rather than having to request and wait in order to communicate. Moreover, this specific type of middleware prefers applications that require messages to be queued and held indefinitely, with examples including workflow and communications apps.

Further, as discussed, the middleware uses a publish/subscribe pattern. For instance, in a message-oriented middleware, it is possible for any program to publish data on the Internet, and interested programs should subscribe to a specific topic of interest. Subscribers look forward to receiving topics from publishers for a certain period of time and afterwards report an exception if the topic is not delivered within that period. As a result, the message passing method is extremely efficient in large distributed systems since neither the sender nor the recipient knows how many users are accessing the information. Additionally, neither party knows which publisher originated the information. Publish/subscribe is a communication model that works best when it comes to dynamic application that require frequent reconfigurations. Moreover, DDS eases adapting the solution based on the given requirements, which leads to the solution being dynamic enough to adapt to a frequently changing environment. DDS has many different QoS specifications that can easily be tailored and modified to fit a specific system and meet the requirements of any design. Furthermore, there are 22 different QoS policies that can be provided and given a certain value. Policies are set for the publisher and the subscriber. In order for the communication to be successful, these policies need to be aligned and consistent with each other. Moreover, some policies can be seen as inter-related to each other and some on the other can be seen as conflicting. However, as every one of these policies are defined at the same time, at incredibly fast speeds, and in a rapidly evolving, challenging, and dynamic environments, the entire potential of DDS becomes apparent.

Herein, each component is configured as a publisher, subscriber or both. The publishers and subscribers then communicate directly with one another over RTPS through near field communication, such as Bluetooth or WiFi. In an operation mode, publishers and subscribers do not communicate over IP. Each component can also communicate over UDP/IP or other internet capable messaging protocol, to configure and update the ACC system 100 and for services which can be performed in other than real-time. The advantage is that there is direct communication among the components over the DDS databus 110. For example, a sensor may act as a publisher and publish an update using RTPS, such as “brakes on at 10% force”. Other components register with the DDS as subscribers to receive brake information. The DDS databus 110 connects these subscriber components to receive this information over the near field communications system, such as Bluetooth. This provides “real time” connectability between the components. It may be noted that, as used herein, “real-time” is not established in terms of actual time, such as ms, s, etc. and varies according to the application. However, for the present ACC system 100, real-time means less than the amount of time it would take a human driver to respond, and may be established as less than one second at the most, and preferably in milliseconds.

The incorporation of the DDS databus 110 and the publish/subscribe DDS middleware 150 ensures a seamless integration of information across the ACC system 100. This integration empowers each component, from the vehicle sensors 120 to the vehicle controllers 130 and the vehicle actuators 140, to concurrently access and act upon uniform data, thereby enhancing the decision-making capabilities of the ACC system 100. The DDS databus 110 and the publish/subscribe DDS middleware 150 simplifies the addition of new components and features to the ACC system 100 by eliminating the need for extensive data flow reconfiguration. This is achieved by connecting additional functionalities directly to the DDS databus 110 and leveraging the publish/subscribe DDS middleware 150 without necessitating modifications to the core programming of the ACC system 100. In some examples, the publish/subscribe DDS middleware 150 is configured to prioritize the data exchange based on current operational needs of the ACC system 100, ensuring that the most critical information is communicated with the highest priority. In general, the publish/subscribe DDS middleware 150 can facilitate concurrent communication and data exchange between different components of the ACC system 100, enhancing system efficiency and reducing latency compared to a strictly hierarchical data flow. This is achieved by providing asynchronous communication, parallel processing, load balancing, and efficient data distribution mechanisms. Overall, the architecture of the DDS databus 110 and the communication management provided by the publish/subscribe DDS middleware 150 facilitates the ACC system 100 in making faster decisions, ensuring the safety of the vehicle.

It may be appreciated that in the ACC system 100, each topic is characterized by a distinct name, ensuring uniqueness within the ACC system 100. Additionally, every topic is associated with a specific type, which outlines the nature and structure of the data therein. In present examples, Quality of Service (QOS) policies define the operational parameters and behavioral attributes of the topics. It may be noted that the data type utilized across these topics is designed to be generic, facilitating uniformity and interoperability across various domains within the ACC system 100. In the present configuration, multiple topics are defined, each serving a distinct purpose and facilitating a specific aspect of the ACC system 100. These topics are managed and manipulated through the roles of data writers and data readers, as defined in the publish/subscribe DDS middleware 150. The data writer within the ACC system 100 is configured to generate a topic and publish it onto the DDS databus 110, making it available to all potential subscribers within the ACC system. Conversely, the data reader is configured to subscribe to these published topics, thereby receiving and processing the data disseminated by the data writers. This dynamic between the data writers and the data readers, defined by the structured organization of the topics and governed by QoS policies, provide the foundation of data exchange within the ACC system 100.

In the ACC system 100, each of the plurality of vehicle sensors 120 is configured in the publish/subscribe DDS middleware 150 as the data writer configured to publish its respective sensor data topic. The vehicle sensors 120 are configured to actively publish their respective sensor data topics, effectively broadcasting the latest measurements of various vehicle parameters to the DDS databus 110. The role of each vehicle sensor 120 as the data writer involves the collection and dissemination of real-time data for the seamless operation of the ACC system 100. The sensor data topics, once published, are made available to the DDS databus 110, from where they can be accessed by other system components which subscribe to these topics. This configuration ensures that there is no delay in the flow of information, providing an efficient and synchronized operation of the ACC system 100.

Further, each of the plurality of vehicle controllers 130 is configured in the publish/subscribe DDS middleware 150 as the data reader configured to subscribe to a subset of the sensor data topics of the plurality of vehicle sensors 120 and as the data writer configured to publish a respective vehicle control topic based on the subset of the sensor data topics. The vehicle controllers 130, as the data readers, are programmed to subscribe to specific subsets of the sensor data topics published by the vehicle sensors 120. Thus, each vehicle controller 130 is able to receive and process the relevant data required for its operational role within the ACC system 100. Once the relevant sensor data topics are received, the vehicle controllers 130 are configured to analyze the information and determine corresponding vehicle control topics. The vehicle control topics are then published back onto the DDS databus 110, to serve as actionable commands for the vehicle actuators 140. This dual capability of the vehicle controllers 130 to both read from and write to the DDS databus 110 provides for translating sensory inputs into precise vehicle actions.

Furthermore, each of the plurality of vehicle actuators 140 is configured in the publish/subscribe DDS middleware 150 as the data reader which subscribes to the vehicle control topics generated by the plurality of vehicle controllers 130. The vehicle actuators 140, as the data readers, are programmed to subscribe to the vehicle control topics that are generated by the vehicle controllers 130. This subscription facilitates the vehicle actuators 140 to receive instructions for the mechanical response necessary for the ACC system 100 to control behavior of the vehicle in real-time. Once the relevant vehicle control topics are received, each vehicle actuator 140 is configured to interpret the vehicle control topics with precision and enact the instructions therein with minimal delay. The vehicle actuators 140, as the data readers in the publish/subscribe DDS middleware 150, act as links in the chain of command within the ACC system 100, converting the analyzed data from the vehicle controllers 130 into physical, responsive action based on the dynamic driving environment and operation of the vehicle.

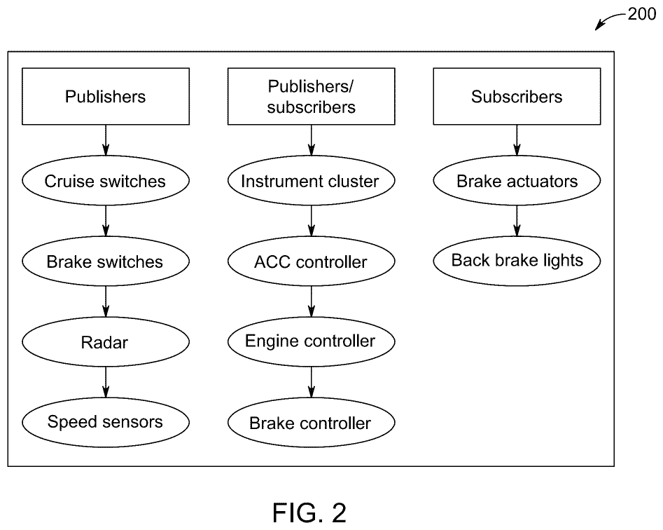

In an exemplary configuration of the ACC system 100, as illustrated in FIG. 1, the plurality of vehicle sensors 120 includes speed sensors 122, radar sensors 124, brake switches 126 and cruise control switches 128. Further, the plurality of vehicle controllers 130 includes an instrument cluster 132, an ACC controller 134, an engine controller 136, and a brake controller 138. Further, the plurality of vehicle actuators 140 includes back brake lights 142 and brake actuators 144. FIG. 2 illustrates a schematic depicting dynamic interaction (as represented by reference numeral 200) between the vehicle sensors 120, including the speed sensors 122, the radar sensors 124, the brake switches 126 and the cruise control switches 128, acting as publishers; the vehicle controllers 130, including the instrument cluster 132, the ACC controller 134, the engine controller 136, and the brake controller 138, acting as publishers/subscribers; and the vehicle actuators 140, including the back brake lights 142 and the brake actuators 144, acting as subscribers.

In an aspect of the present disclosure, the speed sensors 122, the radar sensors 124, the brake switches 126, and the cruise control switches 128 are configured in the publish/subscribe DDS middleware 150 as the publishers of speed sensor topics, radar topics, brake switch topics and cruise control switch topics, respectively. Herein, the speed sensors 122 are configured to monitor velocity of the vehicle and publish this data as the speed sensor topics, including information about a current speed of the vehicle, providing the ACC system 100 to maintain desired cruising speed or to adjust the speed in response to changing traffic conditions. The radar sensors 124 are configured to detect distance and relative speed of objects in path of the vehicle and publish this data as the radar topics, providing the ACC system 100 with data needed to dynamically adjust speed of the vehicle and maintain a safe following distance from the vehicle ahead. The brake switches 126, when engaged, signal the need for the vehicle to decelerate or come to a stop and this data is published as the brake switch topics, alerting the ACC system 100 to an input from the driver and to provide an immediate response in terms of vehicle braking behavior. The cruise control switches 128 permit the driver to set or adjust the desired cruising speed of the vehicle, and this data including the said settings and adjustments is published as the cruise control switch topics. This makes the ACC system 100 to adapt speed of the vehicle according to the driver's preferences.

Further, each of the instrument cluster 132, the ACC controller 134, the engine controller 136, and the brake controller 138 are configured in the publish/subscribe DDS middleware 150 as the subscriber to a subset of the sensor data topics of the plurality of vehicle sensors 120 and as the publisher of a respective vehicle control topic based on the subset of the sensor data topics. Herein, the instrument cluster 132, for instance, subscribes to the speed sensor topics and the radar topics, and publishes the vehicle control topic to provide real-time feedback to the driver regarding the speed of the vehicle and the distance to the vehicle ahead. The ACC controller 134, for instance, subscribes to a broader range of the sensor data topics, including those from the speed sensors 122, the radar sensors 124, and the brake switches 126, and publishes the vehicle control topic related to ACC control data. Thus, the ACC controller 134 can make informed decisions to adjust the speed and the braking of the vehicle to maintain a safe following distance. The engine controller 136, for instance, subscribes to the speed sensor topics and publishes the vehicle control topic to adjust the throttle response based on the data received from the speed sensors 122. The brake controller 138, for instance, subscribes to the radar topics and the brake switch topics from the radar sensors 124 and the brake switches 126, and publishes the vehicle control topic to control the brake actuators 144 in response thereto.

Furthermore, the back brake lights 142 and the brake actuators 144 are configured in the publish/subscribe DDS middleware 150 as the subscribers of topics published by the plurality of vehicle controllers 130. Herein, the back brake lights 142, for instance, subscribe to the vehicle control topics issued by the brake controller 138. When the brake controller 138, for example, publishes a topic indicating the activation of the braking system, the back brake lights 142 respond by illuminating, providing a clear and prompt indication to other road users of deceleration or stopping of the vehicle. Similarly, the brake actuators 144 subscribe to the vehicle control topics issued by the brake controller 138. When the brake controller 138, for example, publishes a topic indicating a change in braking pressure or engagement, the brake actuators 144 activate accordingly, translating the digital command into mechanical action, ensuring that the vehicle can safely adjust its speed or come to a complete stop in response to the dynamic conditions of the road.

Moreover, each of the instrument cluster 132, the ACC controller 134, the engine controller 136, the brake controller 138, the brake actuators 144 and the back brake lights 142 are configured as the data readers configured to read topics published by the cruise control switches 128 and the brake switches 126, the radar sensors 124 and the speed sensors 122, simultaneously. This configuration facilitates the components, including the instrument cluster 132, the ACC controller 134, the engine controller 136, the brake controller 138, the brake actuators 144 and the back brake lights 142, to concurrently read and process topics published by the cruise control switches 128, the brake switches 126, the radar sensors 124, and the speed sensors 122. This simultaneous access to the sensor data topics provides that each of the said components functions based on a holistic view of operational status of the vehicle and an immediate driving environment. Herein, the instrument cluster 132, for instance, by reading the speed sensor topics and the radar topics, can display real-time speed and proximity data to the driver, enhancing situational awareness and safety. The ACC controller 134, for instance, utilizes data from all these sources to make complex decisions regarding speed adjustment, braking, and maintaining safe following distances. The engine controller 136 and the brake controller 138, for instance, by reading the same set of topics, can align their control strategies with the current driving conditions and objectives of the ACC system 100. The brake actuators 144 and the back brake lights 142, for instance, by reading topics related to vehicle speed, proximity to other vehicles, and driver braking commands, can actuate precisely and timely, ensuring that braking actions of the vehicle are effective and communicated to other road users through the activation of the back brake lights 142.

In the ACC system 100 of the present disclosure, each data topic is configured to conform to a set of QoS requirements. The QoS requirements provide the policies which define the operational parameters and behavioral attributes of the topics within the publish/subscribe DDS middleware 150. These policies include aspects such as data delivery reliability, message lifespan, and priority, ensuring that the data exchange meets performance and reliability requirements of the ACC system 100. QOS policies that are used by the publish/subscribe DDS middleware 150 can be used to improve the smoothness of transmission of data through the ACC system 100. In particular, herein, the QoS requirements include durability, presentation, ownership, liveliness, reliability, transport priority and destination order. Table 1 below provides the QoS policies for the publish/subscribe DDS middleware 150.

TABLE 1
The Publisher/Subscriber DDS Middleware QoS policies.

| QoS Policy | Value |
|---|---|
| Durability | TRANSIENT |
| Presentation | Ordered_access |
| Ownership | SHARED |
| Liveliness | MANUAL_BY_PARTICIPANT |
| Reliability | BEST_EFFORT |
| Transport_Priority | Transport_priority |
| Destination_Order | BY_SOURCE_TIMESTAMP |

Durability is configured as a condition of transience in which the data topic is stored until the ACC system is turned OFF. This QoS requirement is concerned with whether the data should outlive their writing time. The writing time is the time the data writer takes writing the instance of a certain topic. Durability is important for the resume topic, as to reset the speed back to the initial set speed, wherein the initial set speed needs to be kept for a while until ACC is cancelled. Therefore, the value chosen for durability is “TRANSIENT;” in which the middleware is only required to keep the data in memory and not in permanent storage. If the Set+ topic issues an instance, durability policy is set to “TRANSIENT” immediately to hold in memory the very first issue for this topic. Moreover, the resume button is actually a data writer publishing through the cruise switches publisher, where the resume button is a subscriber to the Set+ topic and is considered a late joiner that is interested in the very first issue.

The presentation is configured as ordered access in which the data topics are presented to a subscriber in sequential order and as a group access scope in which data topics published by a specific publisher are presented to a subscriber in sequential order. This QOS requirement controls how the samples representing changes to data instances are presented to the subscribing application. Moreover, when it comes to the ACC system 100, the order of changes in instances is important, as a decision needs to be taken at the same exact time. In the case of the leading vehicle urgently braking, such event should be reported at the same time and to guarantee that, the order needs to be strictly monitored. Therefore, the value chosen for presentation is “ordered_access,” as it gives the subscriber the ability to see changes in the same order, they have occurred in. Finally, “access_scope” is set to “GROUP” which makes changes that are made to instances by different data writers that share the same publisher are made available to subscribers on the same order they occur. This is important as the ACC controller 134 needs to be updated by the vehicle sensors 120 continuously and needs to receive changes and updates in order. Moreover, if the ACC system 100 uses a couple of redundant sensors for measuring the distance of the leading vehicle, then “GROUP” is the best fit to be able to monitor the changes made by all these sensors in the subscribing side.

Ownership is a QoS requirement configured to define permission of the subscriber to access a data topic, and the liveliness is set to a condition of manual-by-participant in which the subscribers to a data topic are configured to receive the data topic if at least one of the subscribers is active. This QoS requirement may permit multiple data writers to update the same instance of the data. Choosing the value “EXCLUSIVE” gives the chance to specify one data writer that can modify an instance, while on the other hand, the value “SHARED”, indicates that there is no concept of an owner for the instance. Moreover, to turn off the ACC, the “OFF” topic, only two data writers are authorized to update the instances of the data which are the “Off_Button” data writer and the “Brake_Switch” data writer. In other words, “Off_Button” and “Brake_Switch” are the only two ways to turn off the ACC system 100, therefore it is governed by employing the “OWNERSHIP” policy. Further, the “OWNERSHIP_STRENGTH” is usually defined as a policy that applies the ownership policy in shared context, however, in this case it is unnecessary due to the fact that the two data writers are equally important and should be of the same strength. Therefore, the default is zero and should remain this way.

The reliability is configured as a condition of best effort in which a data topic is transmitted with an expectation of receipt by at least one subscriber. This QoS requirement is concerned with liveliness or the activity status of system entities, and is the mechanism used to determine if an entity is active or not. The value chosen for reliability is “MANUAL_BY_PARTICIPANT,” which declares all entities are active in the “DomainParticipant”, if at least one entity in the same domain is active. Moreover, if one entity in the ACC system 100 is active, all other entities must be active waiting for any update.

The transport priority is configured to control the importance of a data topic in the sequential order of presentation. This QoS requirement is a policy that controls the importance of a topic or a topic's instances, therefore granting the middleware the ability to prioritize more important data. Transport priority can be applied to the safe distance that needs to be left between the leading and following vehicles, and is more crucial if the distance is less than the safe distance than if the distance is over the safe distance.

The destination order is set to source a timestamp which is configured to control the order of the presentation of a data topic depending on its timestamp. This QOS requirement has its main concern as the logical order among changes that are made by the publisher entities to the same instance of data. The value chosen for destination order is “BY_SOURCE_TIMESTAMP,” which indicates that data is ordered depending on the timestamp placed at the source. Moreover, a consistent final value of the data in all the subscribers is guaranteed.

In the ACC system 100, different topics that exist are listed in Table 2 below.

TABLE 2
Topics of ACC model in RTPS model.

| | | Data | Data | | Data | |
|---|---|---|---|---|---|---|
| Topic name | Topic Description | Type | writer | Publisher | reader | Subscriber |
| Brake_Switch | Signal from the | Generic | Brake switch | | 1- Instrument cluster. | |
| | break switch that | | | | 2- Engine controller | |
| | deactivates ACC | | | | 3- ACC controller | |
| | and puts it into | | | | | |
| | standby mode. | | | | | |
| ON | Puts the systems in | Boolean | On button | Cruise | Instrument cluster | |
| | standby mode. | | | switches | | |
| OFF | Turns off the ACC | Boolean | Off button | Cruise | Instrument cluster | |
| | system. | | | switches | | |
| TimeGap+ | Increment the time gap | Generic | Time gap + | Cruise | Instrument cluster | |
| | by 1. | | button | switches | | |
| TimeGap− | Decrement the time | Generic | Time gap − | Cruise | Instrument cluster | |
| | gap by 1. | | button | switches | | |
| Resume | To reset the speed | Generic | Resume | Cruise | Instrument cluster | |
| | back to the initially | | button | switches | | |
| | set speed. | | | | | |
| −Speed | To decelerate | Generic | −speed | Cruise | Instrument cluster | |
| | | | button | switches | | |
| Set+ | Activate the ACC and | Generic | Set+ | Cruise | Instrument cluster | |
| | set the | | button | switches | | |
| | speed/accelerates | | | | | |
| CRZ_RQST | Cruise switch request | Generic | Instrument cluster | | ACC controller | |
| | whenever activated | | | | | |
| ACC_info_msg | ACC information | String | ACC controller | | instrument cluster | |
| | messages from the | | | | | |
| | controller to the | | | | | |
| | driver | | | | | |
| Distance | Between the ACC | Floating- | Radar | | ACC controller | |
| | equipped vehicle and | point | | | | |
| | the leading vehicle | number | | | | |
| V_Lead | Speed of the leading | Floating- | Radar | | ACC controller | |
| | vehicle | point | | | | |
| | | number | | | | |
| Target_v | Target speed to | Floating- | ACC controller | | Engine controller | |
| | maintain safe distance | point | | | | |
| | | number | | | | |
| BRK_DEC_RQST | Deceleration | Generic | ACC controller | | Brake controller | |
| | request from ACC | | | | | |
| | controller | | | | | |
| V_speed | The ACC vehicle speed | Floating- | Brake controller | | 1-ACC controller | |
| | | point | | | 2-Engine controller | |
| | | number | | | | |
| BRK_ACT_COM | The brake | Generic | Brake controller | | Brake Actuator | |
| | actuator | | | | | |
| | command | | | | | |
| Wheel_Speed | Wheel speed by | Floating- | Speed Sensors | | Brake controller | |
| | sensors | point | | | | |
| | | number | | | | |

| | | | | |
|---|---|---|---|---|
| Light_COM | Back break lights | Generic | Brake controller | Back Lights |

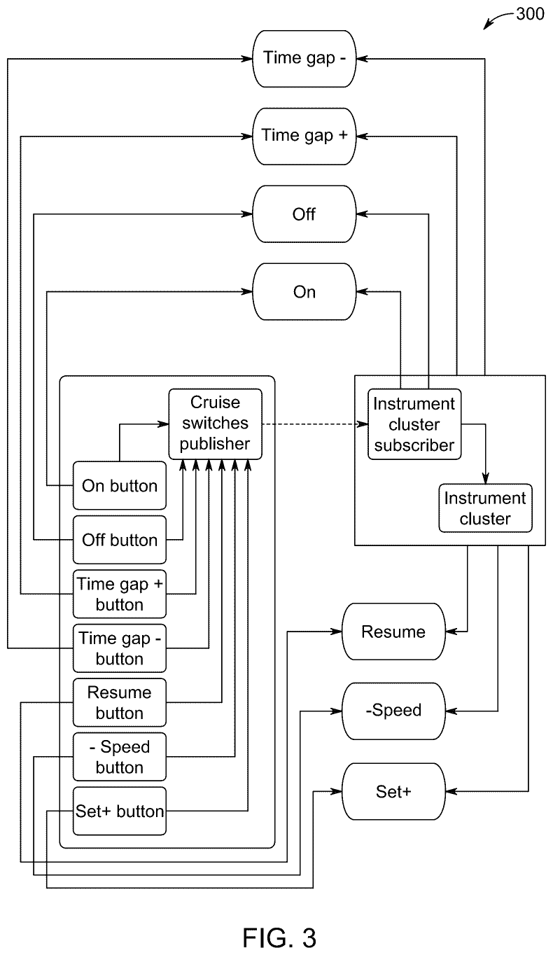

Referring now to FIG. 3, illustrated is a schematic diagram depicting a publish/subscribe relationship framework (as represented by reference numeral 300) between the cruise control switches 128 and the instrument cluster 132. As illustrated, the instrument cluster 132 includes an ON button, an OFF button, a time gap + button, a time gap-button, a resume button, a deceleration speed button, a set button and a cruise request button. Each of the ON button, the OFF button, the time gap + button, the time gap-button, the resume button, the deceleration speed button, the set button and the cruise request button are configured as the data writers which publish data topics according to its status. These data writers are responsible for issuing topics, including TimeGap+, Off, On, Resume, −Speed, Set+, and the like. The instrument cluster 132 is a subscriber to these topics. In other words, every change that occurs in any of these topics will be displayed almost instantaneously on the instrument cluster 132 for the driver to monitor. For example, when the time gap increase (+) button is pressed, it publishes a “TimeGap+” topic, signaling the intent to increase the following distance from the vehicle ahead. Conversely, the time gap decrease (−) button issues a “TimeGap−” topic, indicating a request to reduce the following distance. Similarly, the ON and OFF buttons publish “ON” and “OFF” topics, respectively, which control the activation and deactivation of the ACC system 100. The resume button publishes a “Resume” topic, which commands the vehicle to return to the previously set speed, while the deceleration (−Speed) and set (+Speed) buttons publish “−Speed” and “Set+” topics that instruct the vehicle to decelerate or accelerate to a new set speed.

The ON button is configured to turn ON the ACC system 100. For instance, when engaged by the driver, the ON button initializes the ACC system 100, making it ready to maintain the speed of the vehicle and manage the distance from the vehicle ahead based on preset parameters. The OFF button is configured to turn OFF the ACC system 100. The OFF button may be implemented for situations where manual control is preferred or necessary, ensuring that the driver can promptly revert to traditional driving modes. The time gap+ button is configured to increase a setting of time of impact between a leading vehicle and the vehicle having the ACC system 100. The time gap+ button may be implemented for maintaining a safe following distance, especially at higher speeds or in varying traffic conditions. The time gap-button is configured to decrease a setting of time of impact between a leading vehicle and the vehicle having the ACC system 100. The time gap-button may be implemented in slower traffic conditions where a shorter time gap can be maintained safely. The resume button is configured to reset the speed back to an initially set speed. The resume button may be implemented when the ACC system 100 has been temporarily overridden by, for example, manual braking and the driver wishes to return to the cruise control. The deceleration speed button configured to reduce the speed of the vehicle by a set amount when pressed. The deceleration speed button may be implemented for making fine adjustments, for smoother driving experiences in varying traffic without disengaging the entire ACC system 100. The set button is configured to set the speed of the vehicle when pressed when the ACC system 100 is active. The set button may let the driver set the current speed as the preferred cruising speed. The cruise request button is configured to activate the ACC system 100 when pressed. The cruise request button may be implemented to signal the ACC system 100 to take over the control of speed of the vehicle, based on the current speed and the predetermined following distance. Such functions are conventional and are thus not explained in further detail herein for brevity of the present disclosure.

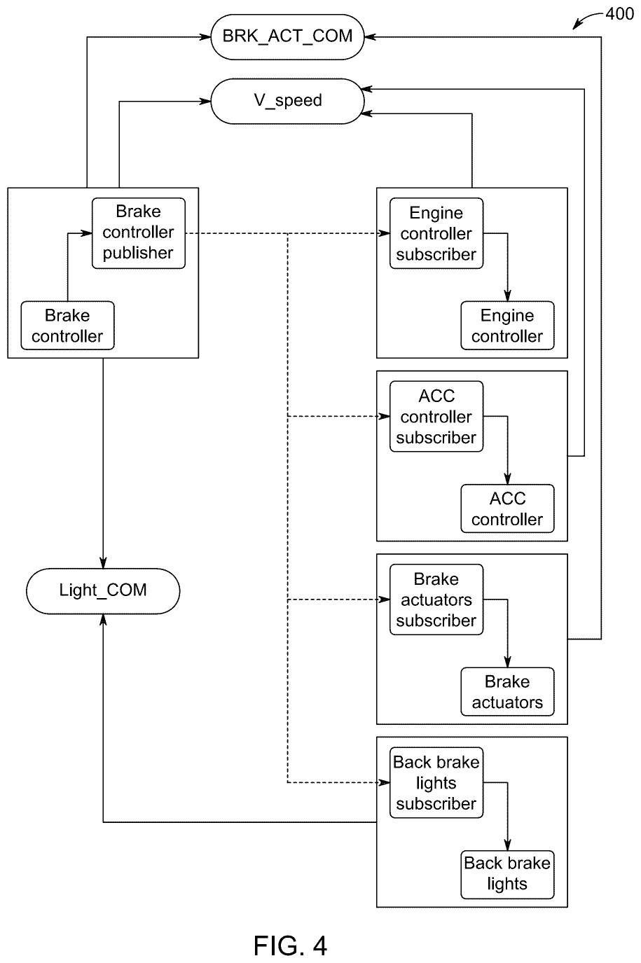

Referring to FIG. 4, illustrated is a schematic diagram of a braking system (as represented by reference numeral 400), for the ACC system 100. In the braking system 400, the relationship between the brake controller 138, the engine controller 136, the ACC controller 134, the brake actuators 144, and the back brake lights 142 is defined. Herein, the brake controller operates as the publisher with a dedicated data writer responsible for issuing three distinct topics within the ACC system 100. Two of these topics, denoted as “BRK_ACT_COM” and “V_speed”, are implemented by the ACC controller 134, the engine controller 136, and the brake actuators 144. The “BRK_ACT_COM” topic is implemented for conveying braking commands, while the “V_speed” topic provides information regarding velocity of the vehicle, for the coordinated operation of the ACC system 100. Furthermore, the back brake lights 142 are configured as subscribers specifically to “Light_COM” topic. This arrangement ensures that whenever the vehicle initiates a braking action, the brake controller 138 publishes an instance in the “Light_COM” topic, permitting the data reader for the back brake lights 142 to track and respond to these braking events reliably. The braking system 400 provides that an efficient communication mechanism is facilitated by the publish/subscribe DDS middleware 150, ensuring that all relevant components are synchronized in real-time.

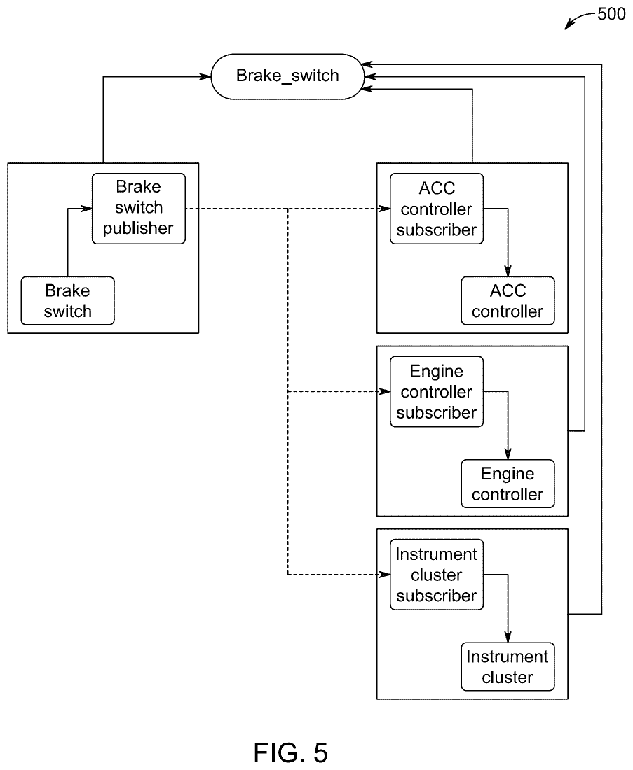

Referring to FIG. 5, illustrated is a schematic diagram of a brake control system (as represented by reference numeral 500), for the ACC system 100. In the brake control system 500, a brake switch operates as the publisher, responsible for issuing the “Brake_Switch” topic. Each activation of the brake switch by the driver generates a new instance of this topic, signaling the need to engage the braking mechanism of the vehicle. The ACC controller 134, the engine controller 136, and the instrument cluster 132 shown in FIG. 1 are configured as the subscribers within this publish/subscribe framework, attuned to the “Brake_Switch” topic and configured to respond when a new instance is published. For instance, the ACC controller 134, as the subscriber, may process the brake signal to adjust vehicle speed and maintain safe driving conditions. Simultaneously, the engine controller 136, upon receiving a brake signal, may adjust engine functions to support the braking action. The instrument cluster 132, also subscribing to the “Brake_Switch” topic, provides the driver with real-time feedback by displaying the braking status. Herein, the publish/subscribe DDS middleware 150 ensures that the communication between the brake switch and the subscribers in the ACC system 100 is instantaneous and reliable, maintaining the operational integrity of the vehicle.

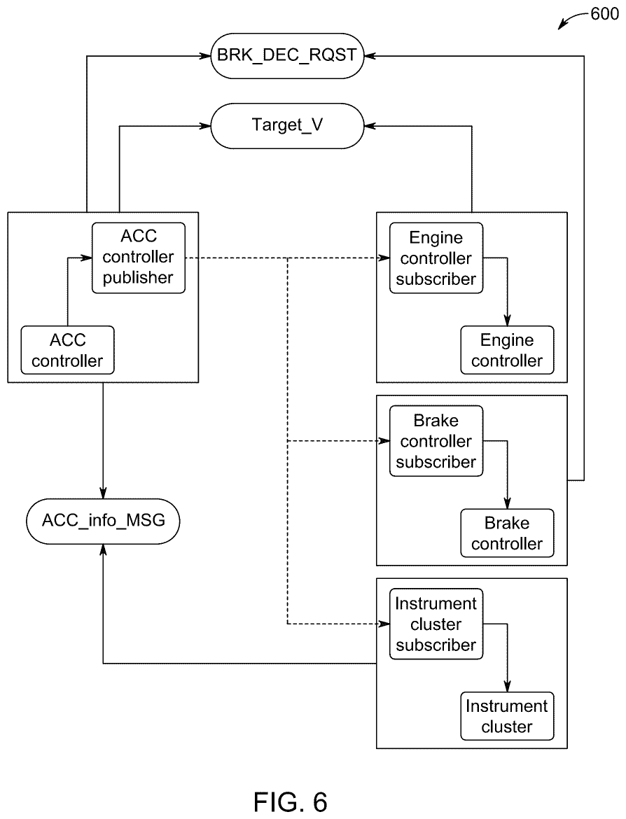

Referring to FIG. 6, illustrated is a schematic diagram of an ACC controller system (as represented by reference numeral 600), for the ACC system 100. The ACC controller system 600 provides the publish/subscribe relationship between the ACC controller 134, the engine controller 136, the brake controller 138, and the instrument cluster 132, for the operation of the adaptive cruise control features. In the ACC controller system 600, the ACC controller 134 functions as the publisher, for issuing three distinct topics to facilitate the adaptive cruise control functions. Herein, the topics, namely “Target_V” and “BRK_DEC_RQST,” are utilized by the engine controller 136 and the brake controller 138, which are configured as the subscribers. The “Target_V” topic communicates the desired vehicle speed set by the ACC controller 134, while the “BRK_DEC_RQST” is a request for brake deceleration when needed to maintain the target vehicle speed or to ensure a safe following distance. Further, a topic “ACC_info_msg” provides various status updates and changes within the ACC system 100. The instrument cluster 132, subscribing to the “ACC_info_msg” topic, receives these updates and presents them to the driver on the instrument cluster, ensuring that any information regarding the adaptive cruise control operation are communicated thereto.

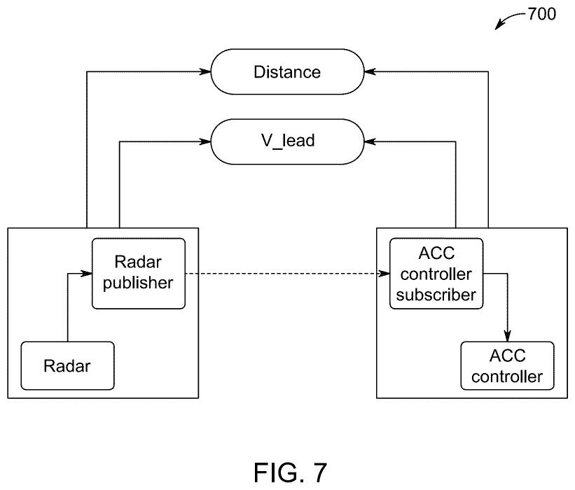

Referring to FIG. 7, illustrated is a schematic diagram of a RADAR system (as represented by reference numeral 700), for the ACC system 100. The RADAR system 700 provides the publisher/subscriber relationship between the radar (as the radar sensor 124) and the ACC controller 134. In the RADAR system 700, the radar serves as the publisher, for detecting and broadcasting data regarding the road ahead. The radar issues two significant topics to which the ACC controller 134 subscribes, namely “Distance” and “V_Lead”. The “Distance” topic provides information about the gap between the vehicle equipped with the ACC system 100 and the leading vehicle, while the “V_Lead” topic provides data on the velocity of the leading vehicle. The ACC controller 134, as the subscriber, receives these topics and utilizes the data for making informed decisions about vehicle speed adjustments and maintaining a safe following distance. By subscribing to the “Distance” and “V_Lead” topics, the ACC controller 134 can dynamically adjust the speed of the vehicle to adapt to the behavior of the leading vehicle and the overall traffic flow, ensuring a safe driving experience.

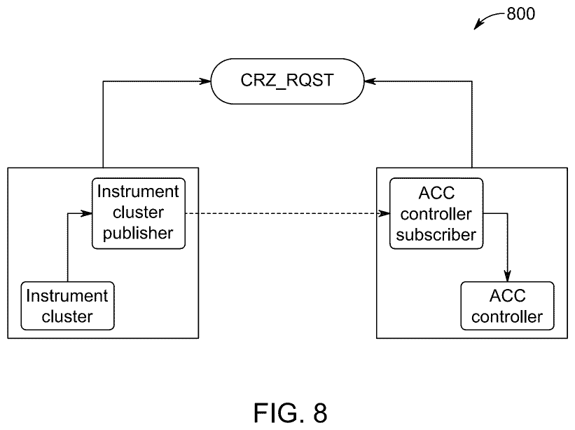

Referring to FIG. 8, illustrated is a schematic diagram of a relationship framework (as represented by reference numeral 800) between the instrument cluster 132 and the ACC controller 134, for the ACC system 100. Herein, the instrument cluster 132 acts as the publisher, and is configured for sending out “CRZ_RQST” topic which represents a cruise control request signal. This topic is generated and released whenever the driver engages the ACC system 100, signaling the desire to initiate the cruise control function. Further, the ACC controller 134 is configured as the subscriber to the “CRZ_RQST” topic, and upon receiving this specific topic, the ACC controller 134 processes the request and activates the ACC system 100 accordingly. This action involves setting the vehicle to maintain a constant speed or a safe following distance from the vehicle ahead, as defined in the ACC system 100.

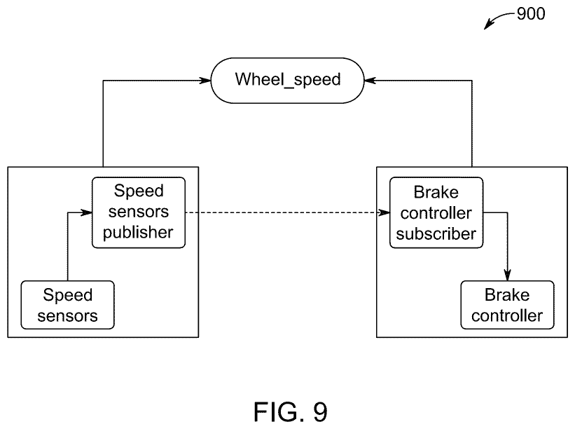

Referring to FIG. 9, illustrated is a schematic diagram of a speed sensors system (as represented by reference numeral 900), for the ACC system 100. The speed sensors system 900 specifically controls the interaction between the speed sensors 122 and the brake controller 138. In the speed sensors system 900, the speed sensors 122 function as the publishers, and are configured to measure wheel speed of the vehicle and publish this data as the “Wheel_Speed” topic. The brake controller 138 is configured as the subscriber to the “Wheel_Speed” topic, and continuously monitors this information to make informed decisions about braking actions. The design of the speed sensors system 900 supports multiple sensors to contribute to the redundancy, with each sensor writing the same “Wheel_Speed” topic. This redundancy ensures that in the event one sensor fails, the speed sensors system 900 can still rely on the data provided by the others, thereby maintaining the reliability of control systems of the vehicle.

In an aspect of the present disclosure, the ACC system 100 includes the brake switch connected to the brake controller 138. Herein, the brake controller 138 is configured to publish a data topic configured to deactivate the ACC system 100 when the brake switch is depressed. In this configuration, the brake controller 138 acts as the publisher within the publish/subscribe DDS middleware 150 and is specifically configured to publish a data topic that carries the command to deactivate the ACC system 100. Activation of the brake switch by the driver triggers the brake controller 138 to publish this deactivation topic, providing immediate manual override of the automated cruise control. This action ensures that when the driver deems it necessary to assume manual control of the vehicle, whether due to a change in driving conditions, an emergency, or a simple preference for manual operation, the ACC system 100 is promptly disengaged.

In an aspect of the present disclosure, the radar sensors 124 are configured to measure a distance of the vehicle from a leading vehicle and a velocity of the leading vehicle and publish a distance data topic and a velocity data topic. That is, the radar sensors 124 are configured to measure the distance from the vehicle to the leading vehicle and the velocity of that leading vehicle, and upon acquiring this data, the radar sensors 124 are configured to publish the distance data topic that provided information about the measured gap to the leading vehicle, and the velocity data topic that provides the information about the speed at which the leading vehicle is traveling. Herein, the ACC controller 134 is configured to subscribe to the distance data topic and velocity data topic and determine when a change in the speed is needed. Further, the ACC controller 134 is configured to publish a speed topic including the change in speed. That is, utilizing this data, the ACC controller 134 is equipped to determine when an adjustment in speed of the vehicle is required, whether it is to maintain a safe following distance or to match the speed of the leading vehicle. In response to the inputs from these topics, the ACC controller 134 calculates the necessary speed changes and publishes a speed topic that includes this information. The instrument cluster 132 is configured to subscribe to the speed topic and actuate one of an increment or decrement of the speed by the engine. That is, once the speed topic is published by the ACC controller 134, the instrument cluster 132 subscribes to it, and initiates an action to either increment or decrement the speed of the vehicle via the engine, depending on the command received. The brake controller 138 is configured to subscribe to the speed topic and publish a brake switch data topic. Further, the brake actuator is configured to subscribe to the brake switch data topic and one of actuate the brakes to slow the speed and actuate a release of the brakes. That is, based on the information from the speed topic, if a reduction in speed is needed, the brake controller 138 publishes the brake switch data topic to effectively communicate the need for braking intervention to the brake actuators 144. The back brake lights 142 are configured to subscribe to the brake switch data topic and one of turn ON the back brake lights and turn OFF the back brake lights. That is, depending on the braking action required, the back brake lights 142 respond accordingly, i.e., illuminating when the brakes are applied to signal trailing vehicles of the deceleration or turning off when the brakes are released.

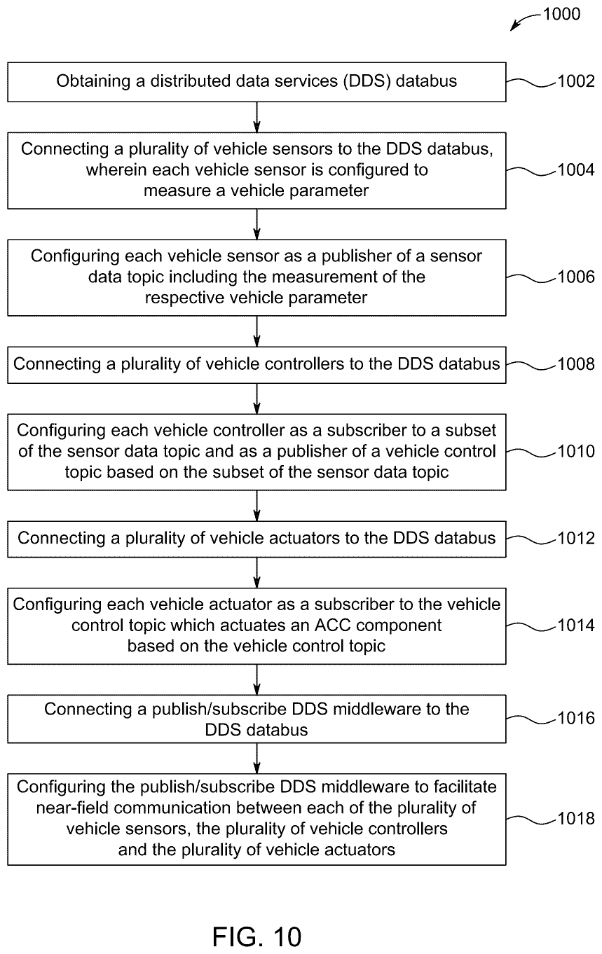

The present disclosure also provides a method for communication in an automatic cruise control (ACC) system (such as, the ACC system 100) for vehicles. Referring to FIG. 10, illustrated is a flowchart listing steps involved a method (as represented by reference numeral 1000) for communication in the ACC system 100. These steps are only illustrative, and other alternatives can also be provided where one or more steps are added, one or more steps are removed, or one or more steps are provided in a different sequence without departing from the scope of the claims herein. Various aspects and variants disclosed above, with respect to the aforementioned ACC system 100 apply mutatis mutandis to the method 1000, as discussed in the proceeding paragraphs.

At step 1002, the method 1000 includes obtaining the distributed data services (DDS) databus 110. That is, the process begins with obtaining the DDS databus 110 which serves as the backbone for data communication within the ACC system 100. The DDS databus 110 is designed to handle the high-speed transfer of data across the ACC system 100, ensuring that all components can communicate with low latency.

At step 1004, the method 1000 includes connecting the plurality of vehicle sensors 120 to the DDS databus 110, wherein each vehicle sensor is configured to measure the vehicle parameter. That is, once the DDS databus 110 is integrated, the plurality of vehicle sensors 120 are connected to it and are configured to measure various vehicle parameters such as speed, distance, and acceleration. Each sensor is then configured as the publisher within the DDS middleware 150.

At step 1006, the method 1000 includes configuring each vehicle sensor 120 as the publisher of the sensor data topic including the measurement of the respective vehicle parameter As publishers, the vehicle sensors 120 are responsible for creating sensor data topics that includes the measurements of their respective vehicle parameters. These topics are made available on the DDS databus 110 for other system components to access.

At step 1008, the method 1000 includes connecting the plurality of vehicle controllers 130 to the DDS databus 110. That is, further integration involves connecting the plurality of vehicle controllers 130 to the DDS databus 110. The vehicle controllers 130, which may include the ACC controller 134, engine controller 136, and brake controller 138, are each configured as subscribers to the relevant sensor data topics published by the vehicle sensors 120. The vehicle controllers 130 actively monitor these topics to retrieve the data necessary for their control functions.

At step 1010, the method 1000 includes configuring each vehicle controller 130 as the subscriber to the subset of the sensor data topic and as the publisher of the vehicle control topic based on the subset of the sensor data topic. That is, additionally, each vehicle controller 130 is configured as the publisher of the vehicle control topic, which is based on the analysis of the subscribed sensor data topics. These control topics contain commands and control strategies based on the analysis of the subscribed sensor data.

At step 1012, the method 1000 includes connecting the plurality of vehicle actuators 140 to the DDS databus 110. That is, a range of vehicle actuators 140 is also connected to the DDS databus 110. The vehicle actuators 140 are the physical components that perform actions like adjusting the throttle, engaging the brakes, or altering the steering based on commands received from the vehicle controllers 130.

At step 1014, the method 1000 includes configuring each vehicle actuator 140 as the subscriber to the vehicle control topic which actuates the ACC component based on the vehicle control topic. That is, the vehicle actuators 140 are configured as the subscribers to the vehicle control topics. When a control topic is received, the vehicle actuator 140 interprets the command and actuates the appropriate component of the ACC system 100 to execute the required action. This actuation can involve adjusting the speed of the vehicle, engaging the brakes, or modifying the throttle position.

At step 1016, the method 1000 includes connecting the publish/subscribe DDS middleware 150 to the DDS databus 110. The publish/subscribe DDS middleware 150 serves as the central hub for data exchange, leveraging the DDS standard to ensure real-time, efficient communication between components of the ACC system 100. The publish/subscribe DDS middleware 150 manages the high-bandwidth data streams for vehicular systems, providing reliable data transfer for the ACC system 100.

At step 1018, the method 1000 includes configuring the publish/subscribe DDS middleware 150 to facilitate near-field communication between each of the plurality of vehicle sensors 120, the plurality of vehicle controllers 130 and the plurality of vehicle actuators 140. That is, once the publish/subscribe DDS middleware 150 is connected, it is then configured to facilitate near-field communication among the vehicle sensors 120, the vehicle controllers 130, and the vehicle actuators 140. This configuration establishes a cohesive network where each component operates synchronously. The near-field communication facilitated by the publish/subscribe DDS middleware 150 is designed to be low latency and high reliability, for safety-critical functions as required in the ACC system 100.

In an aspect of the present disclosure, the method 1000 for communication within the ACC system 100 for vehicles further includes configuring the plurality of vehicle sensors 120, the vehicle controllers 130, and the vehicle actuators 140 in the publish/subscribe DDS middleware 150 to establish a responsive and reliable network for real-time vehicular operations. Specifically, the method 1000 includes configuring each of the plurality of vehicle sensors 120 in the publish/subscribe DDS middleware 150 as the data writer configured to publish the respective sensor data topic. Herein, each vehicle sensor within the ACC system 100 is configured as the data writer in the publish/subscribe DDS middleware 150. This configuration facilitates the vehicle sensors 120 to publish their respective sensor data topics, which may include measurements of vehicle parameters such as speed, proximity, acceleration, and other critical sensory information. As the data writers, the vehicle sensors 120 are configured to capture real-time data from environment and operational state of the vehicle, then formatting and disseminating this information as topics onto the DDS databus 110. The method 1000 further includes configuring each of the plurality of vehicle controllers 130 in the publish/subscribe DDS middleware 150 as the data reader configured to subscribe to the subset of the sensor data topics of the plurality of vehicle sensors 120 and as the data writer configured to publish the respective vehicle control topic based on the subset of the sensor data topics. Herein, the vehicle controllers 130 are configured to function dually as data readers and writers within the DDS middleware 150. As data readers, they subscribe to a curated subset of the sensor data topics published by the vehicle sensors 120. This provides that each vehicle controller 130 receives targeted information necessary for its control tasks, such as maintaining vehicle speed or implementing braking commands. Once this data is analyzed, the vehicle controllers 130 then act as data writers, publishing their own vehicle control topics onto the DDS databus 110. These topics communicate the control actions to be taken by the vehicle actuators 140, thus influencing behavior of the vehicle based on the received sensor data. The method 1000 further includes configuring each of the plurality of vehicle actuators 140 in the publish/subscribe DDS middleware 150 as the data reader configured to subscribe to the vehicle control topics generated by the plurality of vehicle controllers 130. Herein, the vehicle actuators 140 are configured in the DDS middleware 150 as the data readers to subscribe to the vehicle control topics generated by the vehicle controllers 130. Upon receiving these topics, the vehicle actuators 140 interpret the commands and execute the necessary physical adjustments to systems of the vehicle, such as the braking or throttle systems. This systematic configuration of the vehicle sensors 120, the vehicle controllers 130, and the vehicle actuators 140 within the DDS middleware 150 provides a seamless flow of information and control commands across the ACC system 100.

In an aspect of the present disclosure, the method 1000 for communication within the ACC system 100 for vehicles further includes integrating various vehicle sensors 120 and vehicle controllers 130 via the publish/subscribe DDS middleware 150, ensuring seamless communication and control within the ACC system 100. For this purpose, the method 1000 includes configuring each of at least one speed sensor 122, at least one radar sensor 124, at least one brake switch 126 and at least one cruise control switch 128 of the vehicle in the publish/subscribe DDS middleware 150 as the plurality of vehicle sensors 120. Herein, the at least one speed sensor 122, the at least one radar sensor 124, the at least one brake switch 126 and the at least one cruise control switch 128 are configured in the publish/subscribe DDS middleware 150 as publishers of speed sensor topics, radar topics, brake switch topics and cruise control switch topics, respectively. That is, each speed sensor 122, radar sensor 124, brake switch 126, and cruise control switch 128 is configured within the DDS middleware 150 as part of the plurality of vehicle sensors 120. These sensors serve as publishers within the system. In particular, the speed sensor 122 is responsible for monitoring velocity of the vehicle and publishing this information as speed sensor topics. The radar sensor 124 measures the distance to and velocity of the leading vehicle, issuing radar topics based on these measurements. The brake switch 126 detects driver engagement with the braking system of the vehicle and publishes brake switch topics accordingly. The cruise control switch 128, utilized by the driver to set or adjust the cruise control settings, publishes cruise control switch topics. The method 1000 further includes configuring the instrument cluster 132, the ACC controller 134, the engine controller 136, and the brake controller 138 of the vehicle in the publish/subscribe DDS middleware 150 as the plurality of vehicle controllers 130. Herein, each of the instrument cluster 132, the ACC controller 134, the engine controller 136, and the brake controller 138 are configured in the publish/subscribe DDS middleware 150 as the subscriber to the subset of the sensor data topics of the plurality of vehicle sensors 120 and as the publisher of the respective vehicle control topic based on the subset of the sensor data topics. That is, the instrument cluster 132, ACC controller 134, engine controller 136, and brake controller 138 are configured as the plurality of vehicle controllers 130 within the DDS middleware 150. Their configurations empower them to function in dual capacities. In particular, the instrument cluster 132 subscribes to the relevant sensor data topics to display real-time information to the driver and publishes control topics to adjust display settings or alert statuses. The ACC controller 134 subscribes to sensor data topics necessary for maintaining the speed and the distance of the vehicle from other vehicles and publishes vehicle control topics that dictate the speed adjustments required. The engine controller 136 receives data topics related to current and desired speeds of the vehicle, and issues control topics to manage output of the engine accordingly. The brake controller 138 subscribes to data topics that inform it of the need for braking intervention and publishes control topics to engage the braking system. The method 1000 further includes configuring at least one of the back brake light 142 and the brake actuator 144 of the vehicle in the publish/subscribe DDS middleware 150 as the plurality of vehicle actuators 140. Herein, the at least one back brake light 142 and the at least one brake actuator 144 are configured in the publish/subscribe DDS middleware 150 as subscribers of topics published by the plurality of vehicle controllers 130. That is, the vehicle actuators 140, which include at least one back brake light 142 and at least one brake actuator 144, are configured within the DDS middleware 150, and subscribe to control topics issued by the vehicle controllers 130. In particular the back brake light 142, acting as the subscriber, receives topics indicating the need to illuminate or extinguish, responding to braking commands from the brake controller 138. The brake actuator 144 subscribes to brake control topics and is responsible for physically engaging the brakes to slow the vehicle down or releasing the brakes to resume acceleration, based on the received commands. This methodical configuration within the publish/subscribe DDS middleware 150 ensures the ACC system 100 to be robust and responsive.

In an aspect of the present disclosure, the method 1000 for communication within the ACC system 100 for vehicles further includes configuring various interactive elements within the instrument cluster 132 to serve as data writers, each publishing data topics corresponding to their specific functions and statuses. Herein, the method 1000 includes configuring the ON button, the OFF button, the time gap + button, the time gap − button, the resume button, the deceleration speed button, the set button and the cruise request button of the instrument cluster 132 as data writers which publish data topics according to its status. The method 1000 includes configuring the ON button to turn ON the ACC system 100. That is, the ON button is configured to engage the ACC system 100, serving as the initiation point for the automated cruise control. The ON button publishes a data topic that signals the ACC system 100 to activate and take over the speed and distance regulation functions. The method 1000 includes configuring the OFF button turn OFF the ACC system 100. That is, the OFF button is configured with publishing a data topic that instructs the ACC system 100 to disengage, reverting control back to the driver. The OFF button publishes a data topic that signals the ACC system 100 to return control to the driver and disengage the automated features. The method 1000 includes configuring the time gap+ button to increase a setting of time of impact between a leading vehicle and the vehicle having the ACC system 100. That is, the time gap+ button increases the temporal following distance, or “time of impact,” between the ACC-equipped vehicle and the leading vehicle. The time gap+ button publishes a data topic that instructs the ACC system 100 to adjust its parameters to maintain a longer following distance, enhancing safety in varying driving conditions. The method 1000 includes configuring the time gap− to decrease a setting of time of impact between a leading vehicle and the vehicle having the ACC system 100. That is, the time gap− button decreases the set time of impact, promoting closer proximity to the leading vehicle when conditions permit. The time gap-publishes a topic signaling the ACC system 100 to reduce the following distance according to the driver's input. The method 1000 includes configuring the resume button to reset the speed back to an initially set speed. That is, the resume button is configured to publish a topic that commands the ACC system 100 to revert the speed of the vehicle to a previously set value, providing convenience and continuity in vehicle operation after any manual speed adjustments. The method 1000 includes configuring the deceleration speed button to reduce the speed of the vehicle by a set amount when pressed. That is, the deceleration speed button, when activated, publishes a topic that causes the vehicle to reduce speed incrementally, offering the driver to fine-tune the cruising speed without fully disengaging the ACC system 100. The method 1000 includes configuring the set button to set the speed of the vehicle when pressed when the ACC system 100 is active. That is, the set button publishes a topic to establish the current speed as the set point for the ACC system 100 when active, providing the driver to adjust the cruise control setting on the fly. The method 1000 includes configuring the cruise request button to activate the ACC system 100 when pressed. That is, the cruise request button is configured to publish a topic that activates and signals the ACC system 100 to take over speed control of the vehicle based on predefined parameters.

In an aspect of the present disclosure, the method 1000 for communication within the ACC system 100 for vehicles further includes configuring each data topic to comply with a robust set of Quality of Service (QOS) requirements. Herein, the method 1000 includes configuring each data topic to conform to a set of QoS requirements, wherein the QoS requirements include durability, presentation, ownership, liveliness, reliability, transport priority and destination order. These QoS requirements are fundamental to the data communication protocols within the system, ensuring that the data integrity and system performance are optimized. The QoS requirements include durability, presentation, ownership, liveliness, reliability, transport priority, and destination order, each set to meet operational needs of the ACC system 100. The method 1000 further includes configuring durability as a condition of “Transient” in which the data topic is stored until the ACC system 100 is turned OFF. The durability requirement is set to transient, meaning that each data topic is stored only temporarily, remaining available until the ACC system 100 is turned OFF. This setting maintains the latest control commands active and retrievable by the ACC system 100 until no longer needed or until the ACC system 100 is deactivated. The method 1000 includes configuring presentation as ordered access in which the data topics are presented to a subscriber in sequential order and as a group access scope in which data topics published by a specific publisher are presented to a subscriber in sequential order. The presentation QoS requirement is configured for “Ordered Access.” Under this setting, data topics are presented to subscribers in the exact sequence they were published, maintaining the chronological integrity of data flow. Additionally, “Group Access Scope” is employed to ensure that data topics published by a specific publisher are received by subscribers in the order they were issued, for maintaining the sequence of operations and data consistency. The method 1000 includes configuring ownership to define permission of a subscriber to access a data topic. Ownership settings within the QoS requirements specify which subscribers are granted permission to access certain data topics. This definition of rights ensures controlled access to data and avoids potential conflicts in data handling between different system entities. The method 1000 includes setting liveliness to a condition of manual by participant in which subscribers to a data topic are configured to receive the data topic if at least one of the subscribers is active. The “Manual by Participant” condition for liveliness is set to ensure that all subscribers to a data topic are considered active and capable of receiving data as long as at least one participant in the DDS domain is active. This setting maintains an engaged and responsive ACC system 100 where all components are ready to process data as needed. The method 1000 includes configuring reliability as a condition of best effort in which a data topic is transmitted with an expectation of receipt by at least one subscriber. Configured for “Best Effort,” the reliability QoS condition implies that the ACC system 100 attempts to transmit data topics with the expectation that they will be received by at least one subscriber, without guaranteeing delivery. This level of reliability is suitable for data that can tolerate some degree of loss without compromising overall functionality of the ACC system 100. The method 1000 includes configuring transport priority to control the importance of a data topic in the sequential order of presentation. This QoS setting controls the precedence of data topics within the communication framework. By configuring transport priority, the ACC system 100 can ensure that more critical data topics are given precedence in the sequential order of presentation, thereby aligning with the operational priorities. The method 1000 includes setting destination order to source a timestamp which is configured to control the order of the presentation of a data topic depending on its timestamp. The “Source Timestamp” setting for destination order ensures that data topics are presented to subscribers based on the time they were generated by the publisher. This timestamp-based ordering synchronizes actions across the ACC system 100 and maintains temporal accuracy in the execution of control commands.

### Mathematical Model

When the ACC vehicle is moving linearly on a horizontal plane, it is important to create an equilibrium of forces operating in the axis of the vehicle, which corresponds to the x coordinate according to norm. A behavior of this nature can be characterized as

$$\sum Fx = 0 \qquad ( 1 )$$

Wherein, Fx denotes forces operating in vector of the x-axis coordinate. The following is an example of an evolved form of the previous equation:

$$Fo = Rf + Rj + Rv \qquad ( 2 )$$

Fₒ is the circumferential force to a point, R_{f} is the rolling resistance, Rⱼ is the resistance of inertial forces while decelerating, and Ru is the resistance of air. It is required to manage the velocity of the ACC vehicle (v2) in order to obtain higher levels of quality in the job performed by the ACC vehicle. In this case, the vehicle in front v 1 is used to regulate the speed of the vehicle ahead of it, including the distance between the two vehicles (d). Whenever the vehicles are at a certain distance from one another, the separation parameter is further adjusted and maintained constant. This is essential in case the distance between the leading vehicle and the ACC vehicle decreases while the ACC vehicle maintains a constant speed. If this occurs, it is important to activate the brakes of the ACC vehicle. As a result, the velocity of the ACC enabled vehicle is decreased to the same speed as the leading vehicle 1, which is traveling in front of it. It is possible to prevent contact (crash) between the vehicles in this manner.

As long as all horizontal forces are equal on the vehicle, the vehicle's total braking force may be determined. As a result, the ACC vehicle's equation of motion begins to take shape as follow:

$$FK = Rj - Rf + Rv \qquad ( 3 )$$

The braking force is denoted by the variable FK. As the speed of the vehicle lowers, the strength of the produced braking force is significantly greater than the rolling resistance, hence the air and rolling resistance are typically overlooked whenever the vehicle is braking (negligible). Because the braking force estimated are so precise, both resistances are included. When it comes to stopping force, linearity is defined as:

$$Fk = K \cdot t \qquad ( 4 )$$

K is the braking constant and t is the braking time. Because the mass of the vehicle is not distributed evenly everywhere, the breaking force is transferred differentially on front and rear axles to maximize traction between both the tiers and the pavement. Breaking force is important information needed for both axles of the vehicle. In order to calculate the braking constant K, the total of the braking constants of the front and rear axles is used.

$$K = K 1 + K 2 \qquad ( 5 )$$

A vehicle's greatest deceleration is determined by the constant K, which is dependent on the speed of the vehicle ahead of the ACC vehicle. Calculation of maximum deceleration is done as follows.

$${j}_{max} = \frac{{v}_{2}^{2} - {v}_{1}^{2}}{2 \cdot ( D - d )} \qquad ( 6 )$$

D is the distance between vehicles at which ACC begins to operate, and d is the minimum distance at which ACC ceases to function. Velocities v1 and v 2 represent the velocity of the leading vehicle and the ACC equipped vehicle, respectively.

Assuming the vehicle has full braking force capability, the braking force can only be as strong as the maximum braking force of the vehicle.

$$Fkmax = m \cdot jmax = m \cdot g \cdot φmax \qquad ( 7 )$$

jmax is maximum vehicle deceleration, m is mass, g is gravity acceleration, and φmax is maximum coefficient of adhesion. Forces that resist inertia are provided as an example.

$$Rj = m \cdot j \qquad ( 8 )$$

Vehicle deceleration is j and the vehicle's mass is m. The equation for calculating rolling resistance is:

$$Rf = m \cdot g \cdot f \qquad ( 9 )$$

where f is the coefficient of roll-resistance coefficient. The empirical expression used to calculate the rolling resistance of radial tires is:

$$f = f 0 + f 1 \cdot v + f 4 \cdot v 4 \qquad ( 10 )$$

The formula for calculating air resistance is as follows:

$${R}_{v} = \frac{1}{2} \cdot {c}_{x} \cdot A \cdot ρ \cdot {v}^{2} \qquad ( 11 )$$

Where cₓ is the vehicle's drag coefficient, A is its frontal area, and p is the air density. The vehicle's slowing down is referred to as deceleration:

$$j = \frac{{F}_{K} + {R}_{f} + {R}_{v}}{m} \qquad ( 12 )$$

where, v=v₀−∫ J dt is the for calculating both vehicles' velocities, where v 0 is the vehicle's beginning velocity. The calculation of the ACC vehicle travel distance uses the following equation (13_To get the final distance, S=S₀−∫ v dt is used as the starting point. A velocity integral must be calculated for both the ACC and preceding vehicles in order to establish their respective trip distances. ACC enabled vehicles can also have variable or constant vehicle speeds to follow the vehicle(s) in front of them. A distance separates the ACC vehicle and the preceding vehicle defined as:

$$d = s 1 - s 2 \qquad ( 13 )$$

where the first vehicle's trip distance is s₁, and the ACC vehicle's journey distance is s₂.

### Design Model

The speed of the vehicle is adjusted to keep a safe space for both the vehicle with ACC and the vehicle ahead of it in the same lane. This section includes different subsections that describe different driving situations along with the interactions between the driver and the systems for example how to set the speed and how to disengage the system. The subsections are: Switching the system on, setting a Speed, following a Vehicle, Setting the Gap Distance, Disengaging the system, Overriding the system, Changing the Set Speed, Resuming the Set Speed, and Switching the system off. Moreover, each subsection has operational steps that will be mentioned.

### Switching the System on

Activate the On button which is a DataWriter that writes instances of the ON topic. Moreover. a CRZ_RQST instance will be published and whenever the ACC Controller receives the issue, ACC will be ready.

### Setting a Speed

1. Increase the speed to the desired level.
2. Press the SET+button. Set+ is a topic. The memory stores the vehicle speed and because of that the durability QoS policy is employed, to ensure the system does not lose the initial speed after accelerating, as at some point the driver might want to resume the pre-set speed, therefore the topic must outlive its Data Writer.
3. The instrument cluster shows activation of the ACC, gap setting currently in use and intent speed, which are instances and issues of the ACC_info_msg topic.
4. Release the accelerator pedal.
5. When the system detects a vehicle in front of the ACC-equipped vehicle, a vehicle graphic lights in the instrument cluster and the Distance topic will release an issue.

### Following a Vehicle

Whenever a vehicle ahead of the ACC-equipped vehicle joins the same lane or when a slower vehicle joins the same lane, the speed of the vehicle is adjusted to preserve a pre-set gap space. The distance adjustment is user-adjustable. Until one of the following conditions occurs, the vehicle maintains a consistent distance from the vehicle ahead. The conditions are:
i. The leading vehicle accelerates at a higher speed than the predetermined pace, an issue of the V_Lead is published.
ii. The leading vehicle moves out of the lane or out of view.
iii. The speed of the vehicle is reduced to less than 12.4 mph (20 km/h).
iv. The driver establishes a new separation distance.

The system is configured to apply the brakes to the vehicle in order to decelerate and ensure a reasonable distance from the vehicle ahead.

### Setting the Gap Distance/Time

The driver is responsible for selecting a gap that is acceptable for the driving circumstances. The time and distance gaps can be adjusted by the driver using the ‘TimeGap+’ and ‘TimeGap-’ buttons. By pressing the ‘Time Gap+’ switch, the time gap value is increased, resulting in an increase in the clearance between the two vehicles. By tapping the ‘Time Gap-’ switch, the time gap value decreases, resulting in a decrease in the clearance between the two vehicles.

### Disengaging the System

Cruise Control activity can be terminated manually or automatically through the ACC system. ACC will be deactivated if one of the following criteria exists:
The brake pedal is engaged (Brake_Switch Topic)
The ‘Off’ button is held (OFF topic)
The vehicle is traveling at a speed of 12.5 mph or less (V_Speed topic is updated)
An ACC system fault is detected.

### Overriding the System

The driver can alter the pre-set speed and gap distance by pressing the accelerator pedal. When driver releases the accelerator pedal, the system resumes normal operation. The speed of the vehicle is reduced to the predetermined value, or to a lower value if it is trailing a slower vehicle, BRK_DEC_RQST topic in that case releases an issue.

### Changing the Set Speed®

Set the desired speed by accelerating or braking, then pressing and releasing SET+.
Hold down Set+ or Speed− until the information display indicates the required set speed. The speed of the vehicle progressively increases until it reaches the specified speed.
Press and release the Set+ or Speed− buttons. The programmed speed fluctuates by roughly 1.2 miles per hour (2 kilometers per hour).
The system may decelerate in order to reduce the speed of the vehicle to the new specified value. In that case the BRK_DEC_RQST topic publishes a new issue.

### Resuming the Set Speed

The resume option can be used only if the driver is knowledgeable of the pre-set speed and want to return to the pre-set speed. Press and release resume. The vehicle resumes its pre-set speed.

### Switching the System Off

Press and release OFF.

### Experimental Work

This section provides an evaluation of the proposed DDS-based model for ACC system. The main factors that are evaluated and have a significant impact on ACC performance are data rate and the number of publishers/subscribers. The impact of these factors is evaluated using the following performance metrics:

Packet Delivery Ratio (PDR): PDR is calculated by dividing the total number of successfully received messages at the subscriber side by the total sent messages from the publisher side, as shown in formula below. For ideal behavior, this metric is equal to one for all scenarios.

$$P D R = \frac{{\sum }_{0}^{t} Successfully received messages by subscribers}{{\sum }_{0}^{t} sent messages by publishers}$$

End-to-End Delay (EED): Measured from the moment of sending or publishing data on a publisher side (Tₛₑₙₜ) until successfully received on the subscriber side (T_{Received}). The formula shows the calculation of the EED:

$$E E D = \frac{{\sum }_{0}^{i} ( {T}_{Receive} ( i ) - {T}_{sent} ( i ) )}{Number of sucessfuly received messages}$$

Memory footprint: This metric is measured as the number of bytes consumed by the DDS code, when it is uploaded to the sensor/actuator platform. Both RAM and ROM memories are considered in evaluating this metric.

### Simulation Setup:

For the DDS enabled ACC system of the present disclosure, the simulator to be used was the TOSSIM simulator [P. Levis, N. Lee, M. Welsh, and D. Culler, “TOSSIM: accurate and scalable simulation of entire TinyOS applications,” in Proceedings of the 1st international conference on Embedded networked sensor systems, SenSys′03, 2003], which facilitates using sensors and actuators that have embedded systems such as Tiny OS [“TOSSIM, ‘TinyOS Documentation Wiki,’ 2003,” Tinyos.net. (Online). Available: http://docs.tinyos.net/index.php/TOSSIM. (Accessed: 24 Jun. 2022) and TinyDDS [“Tinydds: Publish/Subscribe Middleware for Wireless Sensor Networks,” Google.com. (Online). Available: https://code.google.com/archive/p/tinydds/. (Accessed: 24 Jun. 2022)]. The ACC system was implemented and the simulation run for 500 seconds for each data point of the result. Because the area of the vehicle system was limited, the area was set as 10×10 meters². Table 3 below shows the specific values for the TOSSIM simulation parameters.

TABLE 3
Simulation setup

| Parameter | Value | |
|---|---|---|
| Topology | Squared grid | |
| Area | 10 × 10M² | |
| Number of Nodes | 5, 10, 15, 20, 25 | |
| Packet Size | 20 | bytes |
| Simulation time | 500 | seconds |

| | |
|---|---|
| Runs per results' data point | 10 |

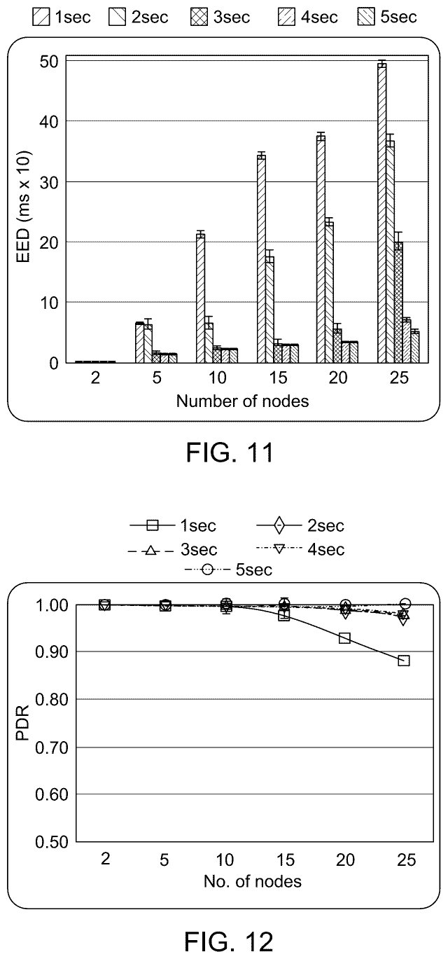

FIG. 11 depicts an end-to-end delay of the ACC messages for different number of nodes (2-25 nodes) and different data rates within the range of 1-5 sec inter-packet interval (IPI). As discussed, the ACC system included about 10 nodes including the ACC, brake, and engine controllers. In this illustration, the delay for 10 or less is roughly less than 100 ms, which is acceptable for a real-time system. To measure the robustness, the number of nodes was extended, as depicted. The worst case for the model was in the case of 1 sec IPI and 25 nodes, where the system was very overloaded, however, it reached about 5 sec EED.

FIG. 12 depicts a packet delivery ratio which shows that the system is reliable even when it is overloaded. Since the system has mostly 10 nodes, the results show that the PDR is about 100% with high data traffic and condense publish/subscribe nodes. Like the EED, the PDR worst case is for 1 sec IPI and 25 nodes, where the system is overloaded, which results because of interferences as well as limited queue buffer size in the used motes.

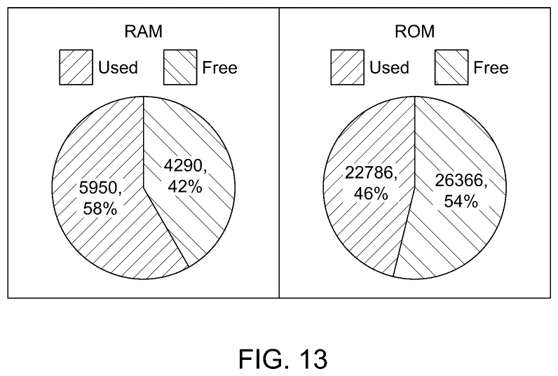

FIG. 13 depicts the simulation results which includes the TinyOS operating system which occupies only 42% and 54% of the system RAM and ROM, respectively, which indicates that the prototype is light and applicable to be deployed over the embedded systems.

The ACC system 100 and the method 1000 of the present disclosure offers several significant advantages over existing ACC systems. The integration of DDS middleware and the publish/subscribe model enhances data communication speed and reliability, effectively reducing system response times. The non-hierarchical data exchange model improves system scalability and flexibility, providing for easy integration of additional sensors and controllers. Further, the detailed QoS policies ensure that data communication meets the stringent requirements of automotive applications, further improving system performance and reliability. Thus, ACC system 100 and the method 1000 of the present disclosure represent a substantial improvement in adaptive cruise control technology, offering enhanced safety, efficiency, and interoperability.

first embodiment describes the automatic cruise control (ACC) system 100 for vehicles, comprising the distributed data services (DDS) databus 110, the plurality of vehicle sensors 120 connected to the DDS databus 110, wherein each vehicle sensor 120 is configured to measure the vehicle parameter and publish the sensor data topic including the measurement of the vehicle parameter, the plurality of vehicle controllers 130 connected to the DDS databus 110, wherein each vehicle controller 130 is configured to subscribe to the subset of the sensor data topic and publish the vehicle control topic based on the subset of the sensor data topic, the plurality of vehicle actuators 140 connected to the DDS databus 110, wherein each vehicle actuator 140 is configured to subscribe to the vehicle control topic and actuate the ACC component based on the vehicle control topic, and the publish/subscribe DDS middleware 150 connected to the DDS databus 110, wherein the publish/subscribe DDS middleware 150 is configured to facilitate near-field communication between each of the plurality of vehicle sensors 120, the plurality of vehicle controllers 130 and the plurality of vehicle actuators 140.

The ACC system 100, wherein each of the plurality of vehicle sensors 120 is configured in the publish/subscribe DDS middleware 150 as the data writer configured to publish its respective sensor data topic.

The ACC system 100, wherein each of the plurality of vehicle controllers 130 is configured in the publish/subscribe DDS middleware 150 as the data reader configured to subscribe to the subset of the sensor data topics of the plurality of vehicle sensors 120 and as the data writer configured to publish the respective vehicle control topic based on the subset of the sensor data topics.

The ACC system 100, wherein each of the plurality of vehicle actuators 140 is configured in the publish/subscribe DDS middleware 150 as the data reader configured to subscribe to the vehicle control topics generated by the plurality of vehicle controllers 130.

The ACC system 100, wherein the plurality of vehicle sensors 120 includes speed sensors 122, radar sensors 124, brake switches 126 and cruise control switches 128.

The ACC system 100, wherein the speed sensors 122, radar sensors 124, brake switches 126, and cruise control switches 128 are configured in the publish/subscribe DDS middleware 150 as publishers of speed sensor topics, radar topics, brake switch topics and cruise control switch topics, respectively.

The ACC system 100, wherein the plurality of vehicle controllers 130 includes the instrument cluster 132, the ACC controller 134, the engine controller 136, and the brake controller 138.

The ACC system 100, wherein each of the instrument cluster 132, the ACC controller 134, the engine controller 136, and the brake controller 138 are configured in the publish/subscribe DDS middleware 150 as the subscriber to the subset of the sensor data topics of the plurality of vehicle sensors 120 and as the publisher of the respective vehicle control topic based on the subset of the sensor data topics.

The ACC system 100, wherein the plurality of vehicle actuators 140 includes back brake lights 142 and brake actuators 144.

The ACC system 100, wherein the back brake lights 142 and the brake actuators 144 are configured in the publish/subscribe DDS middleware 150 as subscribers of topics published by the plurality of vehicle controllers 130.

The ACC system 100, wherein each of the instrument cluster 132, the ACC controller 134, the engine controller 136, the brake controller 138, the brake actuators 144 and the back brake lights 142 are configured as data readers configured to read topics published by the cruise control switches 128 and the brake switches 126, the radar sensors 124 and the speed sensors 122, simultaneously.

The ACC system 100, wherein each data topic is configured to conform to the set of quality of service (QOS) requirements, wherein the QoS requirements include durability, presentation, ownership, liveliness, reliability, transport priority and destination order, wherein the durability is configured as the condition of transience in which the data topic is stored until the ACC system 100 is turned OFF, the presentation is configured as ordered access in which the data topics are presented to the subscriber in sequential order and as the group access scope in which data topics published by the specific publisher are presented to the subscriber in sequential order, the ownership is configured to define permission of the subscriber to access the data topic, the liveliness is set to the condition of manual by participant in which subscribers to the data topic are configured to receive the data topic if at least one of the subscribers is active, the reliability is configured as the condition of best effort in which the data topic is transmitted with the expectation of receipt by at least one subscriber, the transport priority is configured to control the importance of the data topic in the sequential order of presentation, and the destination order is set to source the timestamp which is configured to control the order of the presentation of the data topic depending on its timestamp.

The ACC system 100, wherein the instrument cluster 132 includes the ON button, the OFF button, the time gap + button, the time gap − button, the resume button, the deceleration speed button, the set button and the cruise request button, wherein each of the ON button, the OFF button, the time gap + button, the time gap − button, the resume button, the deceleration speed button, the set button and the cruise request button are configured as data writers which publish data topics according to its status, wherein the ON button is configured to turn ON the ACC system 100, the OFF button is configured to turn OFF the ACC system 100, the time gap+button is configured to increase the setting of time of impact between the leading vehicle and the vehicle having the ACC system 100, the time gap − button is configured to decrease the setting of time of impact between the leading vehicle and the vehicle having the ACC system 100, the resume button is configured to reset the speed back to the initially set speed, the deceleration speed button configured to reduce the speed of the vehicle by the set amount when pressed, the set button is configured to set the speed of the vehicle when pressed when the ACC system 100 is active, and the cruise request button is configured to activate the ACC system 100 when pressed.

The ACC system 100, further comprising the brake switch connected to the brake controller 138, wherein the brake controller 138 is configured to publish the data topic configured to deactivate the ACC system 100 when the brake switch is depressed. The ACC system 100, wherein the radar sensors 124 are configured to measure the distance of the vehicle from the leading vehicle and the velocity of the leading vehicle, and publish the distance data topic and the velocity data topic, wherein the ACC controller 134 is configured to subscribe to the distance data topic and velocity data topic and determine when the change in the speed is needed, wherein the ACC controller 134 is configured to publish the speed topic including the change in speed, wherein the instrument cluster 132 is configured to subscribe to the speed topic and actuate one of the increment or decrement of the speed by the engine, wherein the brake controller 138 is configured to subscribe to the speed topic and publish the brake switch data topic, wherein the brake actuator is configured to subscribe to the brake switch data topic and one of actuate the brakes to slow the speed and actuate the release of the brakes, and wherein the back brake lights 142 are configured to subscribe to the brake switch data topic and one of turn ON the back brake lights 142 and turn OFF the back brake lights 142.

A second embodiment describes a method 1000 for communication in the automatic cruise control (ACC) system 100 for vehicles, comprising obtaining the distributed data services (DDS) databus 110, connecting the plurality of vehicle sensors 120 to the DDS databus 110, wherein each vehicle sensor 120 is configured to measure the vehicle parameter, configuring each vehicle sensor 120 as the publisher of the sensor data topic including the measurement of the respective vehicle parameter, connecting the plurality of vehicle controllers 130 to the DDS databus 110, configuring each vehicle controller 130 as the subscriber to the subset of the sensor data topic and as the publisher of the vehicle control topic based on the subset of the sensor data topic, connecting the plurality of vehicle actuators 140 to the DDS databus 110, configuring each vehicle actuator 140 as the subscriber to the vehicle control topic which actuates the ACC component based on the vehicle control topic, connecting the publish/subscribe DDS middleware 150 to the DDS databus 110, and configuring the publish/subscribe DDS middleware 150 to facilitate near-field communication between each of the plurality of vehicle sensors 120, the plurality of vehicle controllers 130 and the plurality of vehicle actuators 140.

The method 1000, further comprising configuring each of the plurality of vehicle sensors 120 in the publish/subscribe DDS middleware 150 as the data writer configured to publish the respective sensor data topic, configuring each of the plurality of vehicle controllers 130 in the publish/subscribe DDS middleware 150 as the data reader configured to subscribe to the subset of the sensor data topics of the plurality of vehicle sensors 120 and as the data writer configured to publish the respective vehicle control topic based on the subset of the sensor data topics, and configuring each of the plurality of vehicle actuators 140 in the publish/subscribe DDS middleware 150 as the data reader configured to subscribe to the vehicle control topics generated by the plurality of vehicle controllers 130.

The method 1000, further comprising configuring each of at least one speed sensor, at least one radar sensor, at least one brake switch and at least one cruise control switch of the vehicle in the publish/subscribe DDS middleware 150 as the plurality of vehicle sensors 120, wherein the at least one speed sensor, the at least one radar sensor, the at least one brake switch and the at least one cruise control switch are configured in the publish/subscribe DDS middleware 150 as publishers of speed sensor topics, radar topics, brake switch topics and cruise control switch topics, respectively, configuring the instrument cluster 132, the ACC controller 134, the engine controller 136, and the brake controller 138 of the vehicle in the publish/subscribe DDS middleware 150 as the plurality of vehicle controllers 130, wherein each of the instrument cluster 132, the ACC controller 134, the engine controller 136, and the brake controller 138 are configured in the publish/subscribe DDS middleware 150 as the subscriber to the subset of the sensor data topics of the plurality of vehicle sensors 120 and as the publisher of the respective vehicle control topic based on the subset of the sensor data topics, and configuring at least one of the back brake light and the brake actuator of the vehicle in the publish/subscribe DDS middleware 150 as the plurality of vehicle actuators 140, wherein the at least one back brake light and the at least one brake actuator are configured in the publish/subscribe DDS middleware 150 as subscribers of topics published by the plurality of vehicle controllers 130.

The method 1000, further comprising configuring the ON button, the OFF button, the time gap + button, the time gap − button, the resume button, the deceleration speed button, the set button and the cruise request button of the instrument cluster 132 as data writers which publish data topics according to its status, configuring the ON button to turn ON the ACC system 100, configuring the OFF button turn OFF the ACC system 100, configuring the time gap+button to increase the setting of time of impact between the leading vehicle and the vehicle having the ACC system 100, configuring the time gap − to decrease the setting of time of impact between the leading vehicle and the vehicle having the ACC system 100, configuring the resume button to reset the speed back to the initially set speed, configuring the deceleration speed button to reduce the speed of the vehicle by the set amount when pressed, configuring the set button to set the speed of the vehicle when pressed when the ACC system 100 is active, and configuring the cruise request button to activate the ACC system 100 when pressed.

The method 1000, further comprising configuring each data topic to conform to the set of quality of service (QOS) requirements, wherein the QoS requirements include durability, presentation, ownership, liveliness, reliability, transport priority and destination order, configuring durability as the condition of transient in which the data topic is stored until the ACC system 100 is turned OFF, configuring presentation as ordered access in which the data topics are presented to the subscriber in sequential order and as the group access scope in which data topics published by the specific publisher are presented to the subscriber in sequential order, configuring ownership to define permission of the subscriber to access the data topic, setting liveliness to the condition of manual by participant in which subscribers to the data topic are configured to receive the data topic if at least one of the subscribers is active, configuring reliability as the condition of best effort in which the data topic is transmitted with the expectation of receipt by at least one subscriber, configuring transport priority to control the importance of the data topic in the sequential order of presentation, and setting destination order to source the timestamp which is configured to control the order of the presentation of the data topic depending on its timestamp.

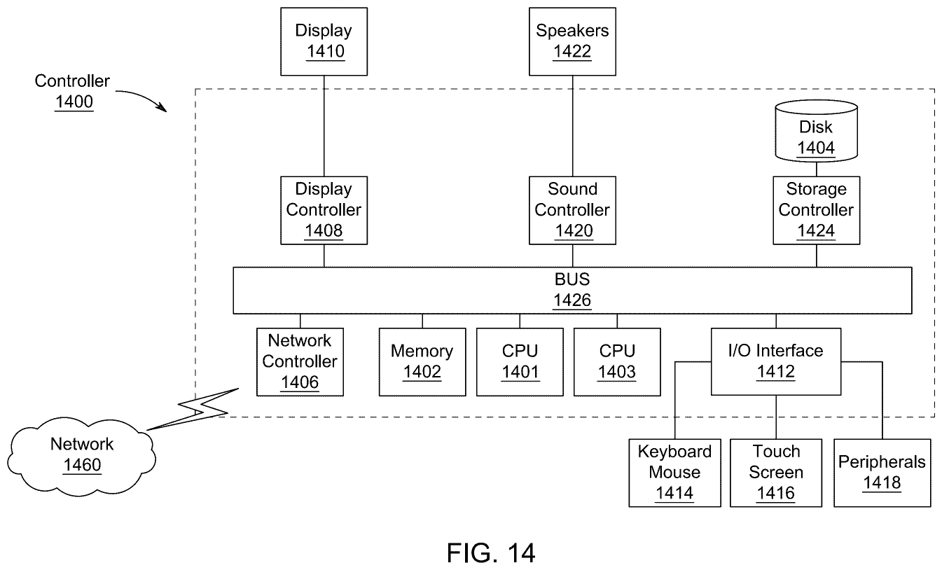

Next, further details of the hardware description of the computing environment according to exemplary embodiments is described with reference to FIG. 14. In FIG. 14, a controller 1400 is described as representative of the ACC system 100 in which the controller is a computing device which includes a CPU 1401 which performs the processes described above/below. The process data and instructions may be stored in memory 1402. These processes and instructions may also be stored on a storage medium disk 1404 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1401, 1403 and an operating system such as Microsoft Windows 7, Microsoft Windows 8, Microsoft Windows 10, UNIX, Solaris, LINUX, Apple MAC-OS, and other systems known to those skilled in the art.

The hardware elements in order to achieve the computing device may be realized by various circuitry elements, known to those skilled in the art. For example, CPU 1401 or CPU 1403 may be a Xenon or Core processor from Intel of America or an Opteron processor from AMD of America, or may be other processor types that would be recognized by one of ordinary skill in the art. Alternatively, the CPU 1401, 1403 may be implemented on an FPGA, ASIC, PLD or using discrete logic circuits, as one of ordinary skill in the art would recognize. Further, CPU 1401, 1403 may be implemented as multiple processors cooperatively working in parallel to perform the instructions of the inventive processes described above.

The computing device in FIG. 14 also includes a network controller 1406, such as an Intel Ethernet PRO network interface card from Intel Corporation of America, for interfacing with network 1460. As can be appreciated, the network 1460 can be a public network, such as the Internet, or a private network such as an LAN or WAN network, or any combination thereof and can also include PSTN or ISDN sub-networks. The network 1460 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1408, such as a NVIDIA GeForce GTX or Quadro graphics adaptor from NVIDIA Corporation of America for interfacing with display 1410, such as a Hewlett Packard HPL2445w LCD monitor. A general purpose I/O interface 1412 interfaces with a keyboard and/or mouse 1414 as well as a touch screen panel 1416 on or separate from display 1410. General purpose I/O interface also connects to a variety of peripherals 1418 including printers and scanners, such as an OfficeJet or DeskJet from Hewlett Packard.

A sound controller 1420 is also provided in the computing device such as Sound Blaster X-Fi Titanium from Creative, to interface with speakers/microphone 1422 thereby providing sounds and/or music.

The general purpose storage controller 1424 connects the storage medium disk 1404 with communication bus 1426, which may be an ISA, EISA, VESA, PCI, or similar, for interconnecting all of the components of the computing device. A description of the general features and functionality of the display 1410, keyboard and/or mouse 1414, as well as the display controller 1408, storage controller 1424, network controller 1406, sound controller 1420, and general purpose I/O interface 1412 is omitted herein for brevity as these features are known.

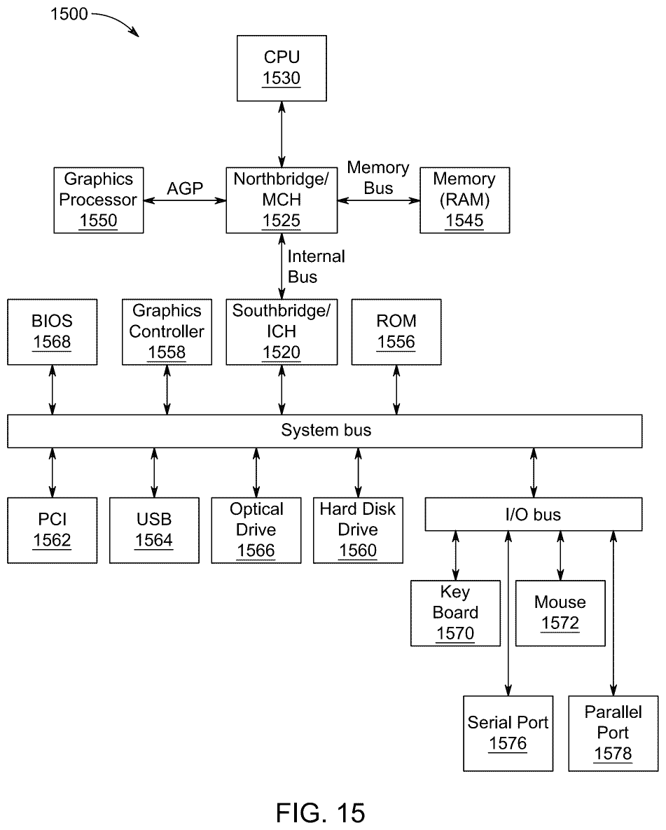

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 15.

FIG. 15 shows a schematic diagram of a data processing system, according to certain embodiments, for performing the functions of the exemplary embodiments. The data processing system is an example of a computer in which code or instructions implementing the processes of the illustrative embodiments may be located.

In FIG. 15, data processing system 1500 employs a hub architecture including a north bridge and memory controller hub (NB/MCH) 1525 and a south bridge and input/output (I/O) controller hub (SB/ICH) 1520. The central processing unit (CPU) 1530 is connected to NB/MCH 1525. The NB/MCH 1525 also connects to the memory 1545 via a memory bus, and connects to the graphics processor 1550 via an accelerated graphics port (AGP). The NB/MCH 1525 also connects to the SB/ICH 1520 via an internal bus (e.g., a unified media interface or a direct media interface). The CPU Processing unit 1530 may contain one or more processors and even may be implemented using one or more heterogeneous processor systems.

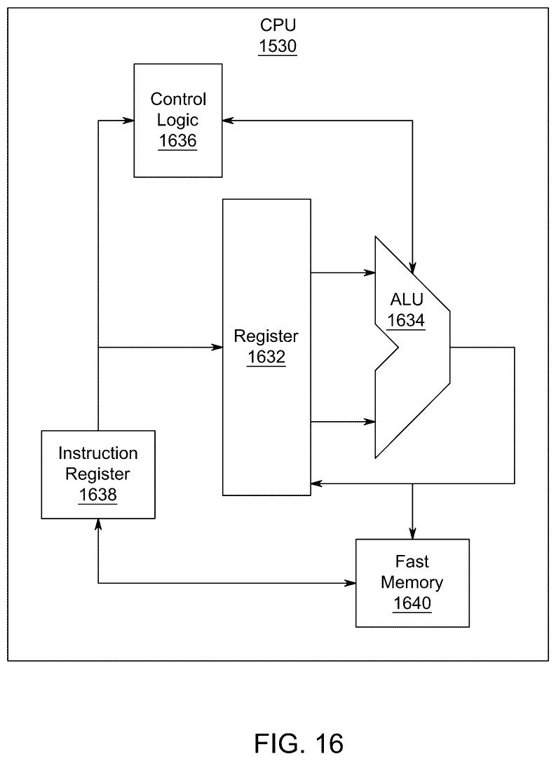

For example, FIG. 16 shows one implementation of CPU 1530. In one implementation, the instruction register 1638 retrieves instructions from the fast memory 1640. At least part of these instructions are fetched from the instruction register 1638 by the control logic 1636 and interpreted according to the instruction set architecture of the CPU 1530. Part of the instructions can also be directed to the register 1632. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1634 that loads values from the register 1632 and performs logical and mathematical operations on the loaded values according to the instructions. The results from these operations can be feedback into the register and/or stored in the fast memory 1640. According to certain implementations, the instruction set architecture of the CPU 1530 can use a reduced instruction set architecture, a complex instruction set architecture, a vector processor architecture, a very large instruction word architecture. Furthermore, the CPU 1530 can be based on the Von Neuman model or the Harvard model. The CPU 1530 can be a digital signal processor, an FPGA, an ASIC, a PLA, a PLD, or a CPLD. Further, the CPU 1530 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 15, the data processing system 1500 can include that the SB/ICH 1520 is coupled through a system bus to an I/O Bus, a read only memory (ROM) 1556, universal serial bus (USB) port 1564, a flash binary input/output system (BIOS) 1568, and a graphics controller 1558. PCI/PCIe devices can also be coupled to SB/ICH 1588 through a PCI bus 1562.

The PCI devices may include, for example, Ethernet adapters, add-in cards, and PC cards for notebook computers. The Hard disk drive 1560 and CD-ROM 1566 can use, for example, an integrated drive electronics (IDE) or serial advanced technology attachment (SATA) interface. In one implementation the I/O bus can include a super I/O (SIO) device.

Further, the hard disk drive (HDD) 1560 and optical drive 1566 can also be coupled to the SB/ICH 1520 through a system bus. In one implementation, a keyboard 1570, a mouse 1572, a parallel port 1578, and a serial port 1576 can be connected to the system bus through the I/O bus. Other peripherals and devices that can be connected to the SB/ICH 1520 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

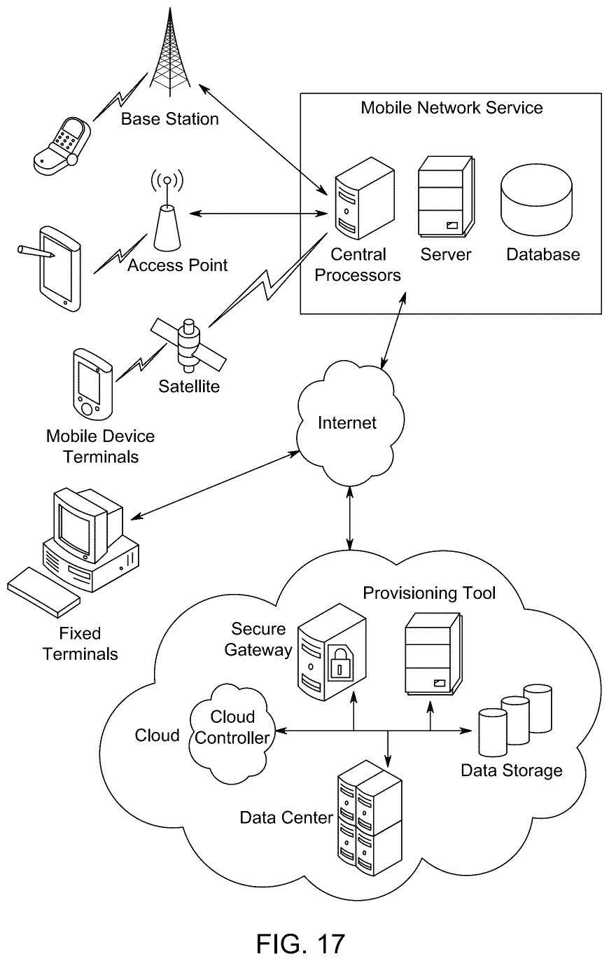

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 17, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An automatic cruise control (ACC) system for vehicles, comprising:
a distributed data services (DDS) databus;
a plurality of vehicle sensors connected to the DDS databus, wherein each vehicle sensor is configured to measure a vehicle parameter and publish a sensor data topic including the measurement of the vehicle parameter;
a plurality of vehicle controllers connected to the DDS databus, wherein each vehicle controller is configured to subscribe to a subset of the sensor data topic and publish a vehicle control topic based on the subset of the sensor data topic;
a plurality of vehicle actuators connected to the DDS databus, wherein each vehicle actuator is configured to subscribe to the vehicle control topic and actuate an ACC component based on the vehicle control topic; and
a publish/subscribe DDS middleware connected to the DDS databus, wherein the publish/subscribe DDS middleware is configured to facilitate near-field communication between each of the plurality of vehicle sensors, the plurality of vehicle controllers and the plurality of vehicle actuators.

2. The ACC system of claim 1, wherein each of the plurality of vehicle sensors is configured in the publish/subscribe DDS middleware as a data writer configured to publish its respective sensor data topic.

3. The ACC system of claim 2, wherein each of the plurality of vehicle controllers is configured in the publish/subscribe DDS middleware as a data reader configured to subscribe to a subset of the sensor data topics of the plurality of vehicle sensors and as a data writer configured to publish a respective vehicle control topic based on the subset of the sensor data topics.

4. The ACC system of claim 3, wherein each of the plurality of vehicle actuators is configured in the publish/subscribe DDS middleware as a data reader configured to subscribe to the vehicle control topics generated by the plurality of vehicle controllers.

5. The ACC system of claim 1, wherein the plurality of vehicle sensors includes speed sensors, radar sensors, brake switches and cruise control switches.

6. The ACC system of claim 5, wherein the speed sensors, radar sensors, brake switches, and cruise control switches are configured in the publish/subscribe DDS middleware as publishers of speed sensor topics, radar topics, brake switch topics and cruise control switch topics, respectively.

7. The ACC system of claim 6, wherein the plurality of vehicle controllers includes an instrument cluster, an ACC controller, an engine controller, and a brake controller.

8. The ACC system of claim 7, wherein each of the instrument cluster, the ACC controller, the engine controller, and the brake controller are configured in the publish/subscribe DDS middleware as a subscriber to a subset of the sensor data topics of the plurality of vehicle sensors and as a publisher of a respective vehicle control topic based on the subset of the sensor data topics.

9. The ACC system of claim 8, wherein the plurality of vehicle actuators includes back brake lights and brake actuators.

10. The ACC system of claim 9, wherein the back brake lights and the brake actuators are configured in the publish/subscribe DDS middleware as subscribers of topics published by the plurality of vehicle controllers.

11. The ACC system of claim 10, wherein each of the instrument cluster, the ACC controller, the engine controller, the brake controller, the brake actuators and the back brake lights are configured as data readers configured to read topics published by the cruise control switches and the brake switches, the radar sensors and the speed sensors, simultaneously.

12. The ACC system of claim 11, wherein each data topic is configured to conform to a set of quality of service (QOS) requirements, wherein the QoS requirements include durability, presentation, ownership, liveliness, reliability, transport priority and destination order, wherein:
durability is configured as a condition of transience in which the data topic is stored until the ACC system is turned OFF,
presentation is configured as ordered access in which the data topics are presented to a subscriber in sequential order and as a group access scope in which data topics published by a specific publisher are presented to a subscriber in sequential order,
ownership is configured to define permission of a subscriber to access a data topic,
liveliness is set to a condition of manual by participant in which subscribers to a data topic are configured to receive the data topic if at least one of the subscribers is active,
reliability is configured as a condition of best effort in which a data topic is transmitted with an expectation of receipt by at least one subscriber,
transport priority is configured to control the importance of a data topic in the sequential order of presentation, and
destination order is set to source a timestamp which is configured to control the order of the presentation of a data topic depending on its timestamp.

13. The ACC system of claim 11, wherein the instrument cluster includes an ON button, an OFF button, a time gap + button, a time gap − button, a resume button, a deceleration speed button, a set button and a cruise request button, wherein each of the ON button, the OFF button, the time gap + button, the time gap − button, the resume button, the deceleration speed button, the set button and the cruise request button are configured as data writers which publish data topics according to its status, wherein:
the ON button is configured to turn ON the ACC system,
the OFF button is configured to turn OFF the ACC system,
the time gap+ button is configured to increase a setting of time of impact between a leading vehicle and the vehicle having the ACC system,
the time gap−button is configured to decrease a setting of time of impact between a leading vehicle and the vehicle having the ACC system,
the resume button is configured to reset the speed back to an initially set speed,
the deceleration speed button configured to reduce the speed of the vehicle by a set amount when pressed,
the set button is configured to set the speed of the vehicle when pressed when the ACC system is active, and
the cruise request button is configured to activate the ACC system when pressed.

14. The ACC system of claim 11, further comprising:
a brake switch connected to the brake controller, wherein the brake controller is configured to publish a data topic configured to deactivate the ACC system when the brake switch is depressed.

15. The ACC system of claim 11, wherein:
the radar sensors are configured to measure a distance of the vehicle from a leading vehicle and a velocity of the leading vehicle, and publish a distance data topic and a velocity data topic,
wherein the ACC controller is configured to subscribe to the distance data topic and velocity data topic and determine when a change in the speed is needed,
wherein the ACC controller is configured to publish a speed topic including the change in speed,
wherein the instrument cluster is configured to subscribe to the speed topic and actuate one of an increment or decrement of the speed by the engine,
wherein the brake controller is configured to subscribe to the speed topic and publish a brake switch data topic,
wherein the brake actuator is configured to subscribe to the brake switch data topic and one of actuate the brakes to slow the speed and actuate a release of the brakes, and
wherein the back brake lights are configured to subscribe to the brake switch data topic and one of turn ON the back brake lights and turn OFF the back brake lights.

16. A method for communication in an automatic cruise control (ACC) system for vehicles, comprising:
obtaining a distributed data services (DDS) databus;
connecting a plurality of vehicle sensors to the DDS databus, wherein each vehicle sensor is configured to measure a vehicle parameter;
configuring each vehicle sensor as a publisher of a sensor data topic including the measurement of the respective vehicle parameter;
connecting a plurality of vehicle controllers to the DDS databus;
configuring each vehicle controller as a subscriber to a subset of the sensor data topic and as a publisher of a vehicle control topic based on the subset of the sensor data topic;
connecting a plurality of vehicle actuators to the DDS databus;
configuring each vehicle actuator as a subscriber to the vehicle control topic which actuates an ACC component based on the vehicle control topic;
connecting a publish/subscribe DDS middleware to the DDS databus; and
configuring the publish/subscribe DDS middleware to facilitate near-field communication between each of the plurality of vehicle sensors, the plurality of vehicle controllers and the plurality of vehicle actuators.

17. The method of claim 16, further comprising:
configuring each of the plurality of vehicle sensors in the publish/subscribe DDS middleware as a data writer configured to publish a respective sensor data topic;
configuring each of the plurality of vehicle controllers in the publish/subscribe DDS middleware as a data reader configured to subscribe to a subset of the sensor data topics of the plurality of vehicle sensors and as a data writer configured to publish a respective vehicle control topic based on the subset of the sensor data topics; and
configuring each of the plurality of vehicle actuators in the publish/subscribe DDS middleware as a data reader configured to subscribe to the vehicle control topics generated by the plurality of vehicle controllers.

18. The method of claim 17, further comprising:
configuring each of at least one speed sensor, at least one radar sensor, at least one brake switch and at least one cruise control switch of the vehicle in the publish/subscribe DDS middleware as the plurality of vehicle sensors,
wherein the at least one speed sensor, the at least one radar sensor, the at least one brake switch and the at least one cruise control switch are configured in the publish/subscribe DDS middleware as publishers of speed sensor topics, radar topics, brake switch topics and cruise control switch topics, respectively,
configuring an instrument cluster, an ACC controller, an engine controller, and a brake controller of the vehicle in the publish/subscribe DDS middleware as the plurality of vehicle controllers,
wherein each of the instrument cluster, the ACC controller, the engine controller, and the brake controller are configured in the publish/subscribe DDS middleware as a subscriber to a subset of the sensor data topics of the plurality of vehicle sensors and as a publisher of a respective vehicle control topic based on the subset of the sensor data topics; and
configuring at least one of a back brake light and a brake actuator of the vehicle in the publish/subscribe DDS middleware as the plurality of vehicle actuators,
wherein the at least one back brake light and the at least one brake actuator are configured in the publish/subscribe DDS middleware as subscribers of topics published by the plurality of vehicle controllers.

19. The method of claim 18, further comprising:
configuring an ON button, an OFF button, a time gap + button, a time gap − button, a resume button, a deceleration speed button, a set button and a cruise request button of the instrument cluster as data writers which publish data topics according to its status;
configuring the ON button to turn ON the ACC system;
configuring the OFF button turn OFF the ACC system;
configuring the time gap+ button to increase a setting of time of impact between a leading vehicle and the vehicle having the ACC system;
configuring the time gap− to decrease a setting of time of impact between a leading vehicle and the vehicle having the ACC system;
configuring the resume button to reset the speed back to an initially set speed;
configuring the deceleration speed button to reduce the speed of the vehicle by a set amount when pressed;
configuring the set button to set the speed of the vehicle when pressed when the ACC system is active; and
configuring the cruise request button to activate the ACC system when pressed.

20. The method of claim 16, further comprising:
configuring each data topic to conform to a set of quality of service (QOS) requirements, wherein the QoS requirements include durability, presentation, ownership, liveliness, reliability, transport priority and destination order;
configuring durability as a condition of transient in which the data topic is stored until the ACC system is turned OFF,
configuring presentation as ordered access in which the data topics are presented to a subscriber in sequential order and as a group access scope in which data topics published by a specific publisher are presented to a subscriber in sequential order,
configuring ownership to define permission of a subscriber to access a data topic,
setting liveliness to a condition of manual by participant in which subscribers to a data topic are configured to receive the data topic if at least one of the subscribers is active,
configuring reliability as a condition of best effort in which a data topic is transmitted with an expectation of receipt by at least one subscriber,
configuring transport priority to control the importance of a data topic in the sequential order of presentation, and
setting destination order to source a timestamp which is configured to control the order of the presentation of a data topic depending on its timestamp.
